(19) United States
(12) Patent Application Publication
(10) Pub. No.: US 2007/0197288 A1
(43) Pub. Date: Aug. 23, 2007

(54) GAMING MACHINE

(75) Inventors: Jun Fujimoto, Tokyo (JP); Masatsugu Kobayashi, Tokyo (JP); Keika Yokoyama, Tokyo (JP); Hiroshi Ohno, Tokyo (JP); Tomoaki Oomori, Tokyo (JP); Mayumi Takeda, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Koto-ku (JP)

(21) Appl. No.: 11/675,860

(22) Filed: Feb. 16, 2007

(30) Foreign Application Priority Data
Feb. 22, 2006 (JP) P2006-045896
Feb. 22, 2006 (JP) P2006-045885
Feb. 22, 2006 (JP) P2006-045911

(51) Int. Cl. A63F 13/00

(52) U.S. Cl. 463/31

(57) ABSTRACT

A gaming machine includes an operation controller, a processor, and a display. The operation controller accepts an operation of a player, and the processor controls a game based on the operation of the player accepted by the operation controller. The display simultaneously displays a first image that can be recognized visually from a first viewing angle direction and a second image that can be recognized visually from a second viewing angle direction different from the first viewing angle direction. The processor controls the display so as to display a game image relating to the game as the first image and to display game information based on a game process relating to the game controlled by the processor as the second image.

### CROSS REFERENCE TO RELATED APPLICATIONS

This application is based upon and claims the benefit of priorities from the prior Japanese Patent Applications No. 2006-045885 filed on Feb. 22, 2006, No. 2006-045896 filed on Feb. 22, 2006 and No. 2006-045911 filed on Feb. 22, 2006, the entire contents of all of which are incorporated herein by reference.

### BACKGROUND OF THE INVENTION

1. Field of the Invention

The present invention relates to a gaming machine that displays game images relating to a game controlled based on the operation etc. of a player and, more particularly, to a gaming machine comprising a display means for displaying different information depending on the viewing angle direction.

2. Related Background of the Invention

A liquid crystal display is a display unit which includes a liquid crystal layer having an anisotropic dielectric coefficient and being injected between two substrates and which displays a desired static image or motion image by adjusting the strength of an electric field to be applied to the liquid crystal layer to adjust the amount of light transmitting the substrates. Such a liquid crystal display is excellent in reduction in weight, thickness, power consumption, etc., and is generally employed as a display unit of an measuring instrument, medical device, industrial device, not limited to more familiar devices, such as a mobile phone, car navigator, PDA, personal computer, TV, etc.

Recently, a display referred to as a dual-view liquid crystal or a duel-view liquid crystal has been proposed as the above-mentioned liquid crystal display, which displays different images simultaneously depending on the viewing angle direction (for example, Japanese Patent Application Laid-Open No. 2005-99787). This allows simultaneous display of different images on a single screen without the need to switch screens or split the screen. Then, it has been desired to apply the above-mentioned dual-view liquid crystal or duel-view liquid crystal to various fields by utilizing the characteristic thereof.

### SUMMARY OF THE INVENTION

An object of the present invention is to provide a gaming machine that has improved convenience of a player or a person around the player by applying a display that displays different information depending on the viewing angle direction.

The present invention provides a gaming machine including an operation controller accepting an operation of a player; a processor controlling a game based on the operation of the player which is accepted by the operation controller; and a display simultaneously displaying a first image that can be recognized visually from a first viewing angle direction and a second image that can be recognized visually from a second viewing angle direction different from the first viewing angle direction on a single image display panel, wherein the processor controls the display so as to display a game image relating to the game as the first image and to display game information based on a game process relating to the game controlled by the processor as the second image.

### BRIEF DESCRIPTION OF THE DRAWINGS

FIG. 1 is a perspective view showing the appearance of a slot machine according to the present embodiment.

FIG. 2 is a plan view schematically showing the structure of an upper image display panel.

FIG. 3 is a schematic diagram showing symbol columns drawn on the outer circumferential surface of each reel.

FIG. 4 is a block diagram schematically showing a control system of the slot machine according to the present embodiment.

FIG. 5 is a diagram showing a payout table showing winning patterns, the possibility of achievement of each pattern, and the payout of the slot machine in the present embodiment.

FIG. 6 is a flow chart of a main control process program in a slot machine according to first to third examples of the present embodiment.

FIG. 7 is a flow chart of a main game process program in the slot machine according to the first example of the present embodiment.

FIG. 8 is a diagram showing an example of a game image and a history image displayed on the upper image display panel in a main game process according to the first example.

FIG. 9 is a diagram describing explanatory notes displayed on the upper image display panel in the slot machine according to the second example of the present embodiment.

FIG. 10 is a flow chart of a main game process program in the slot machine according to the second example of the present embodiment.

FIG. 11 is a flow chart of a bonus game process program in the slot machine according to the second example of the present embodiment.

FIG. 12 is a diagram showing an example of a game image and an explanatory image displayed on the upper image display panel in the main game process according to the second example.

FIG. 13 is a flow chart of a main game process program in the slot machine according to the third example of the present embodiment.

FIG. 14 is a diagram showing an example of an image displayed on the upper image display panel in a main game process according to a third example.

FIG. 15 is a diagram showing an example of an image displayed on the upper image display panel when an award is won at an internal lottery in a bonus game according to the third example.

### DESCRIPTION OF THE PREFERRED EMBODIMENTS

A gaming machine according to the present invention will be described below in detail based on embodiments in which the gaming machine has been embodied in a slot machine with reference to drawings.

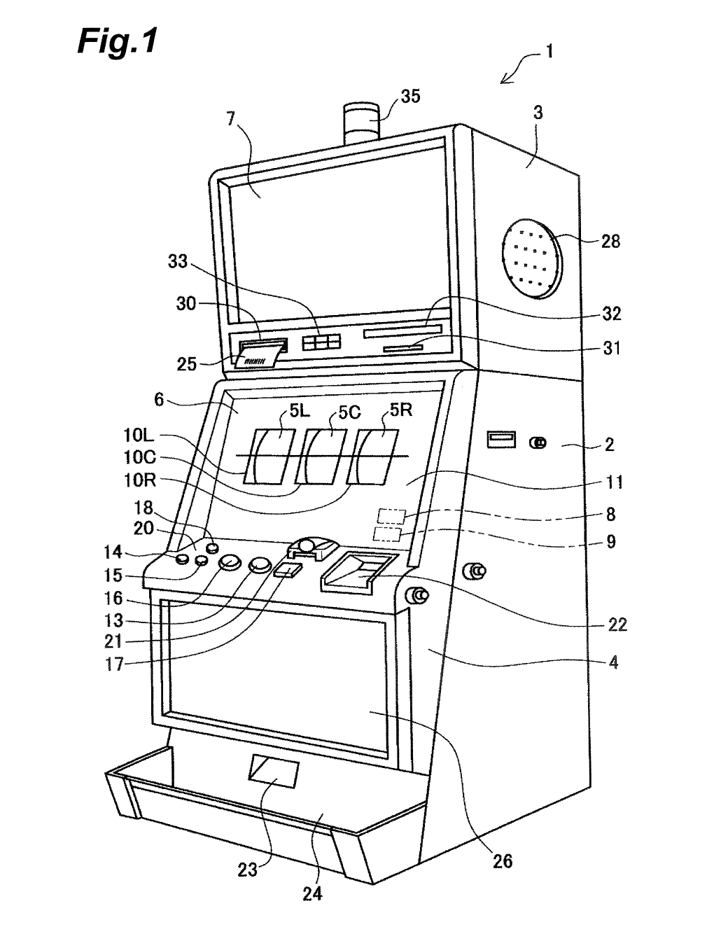

First, a general configuration of a slot machine 1 according to the present embodiment will be described based on FIG. 1. FIG. 1 is a perspective view of the appearance of the slot machine according to the present embodiment.

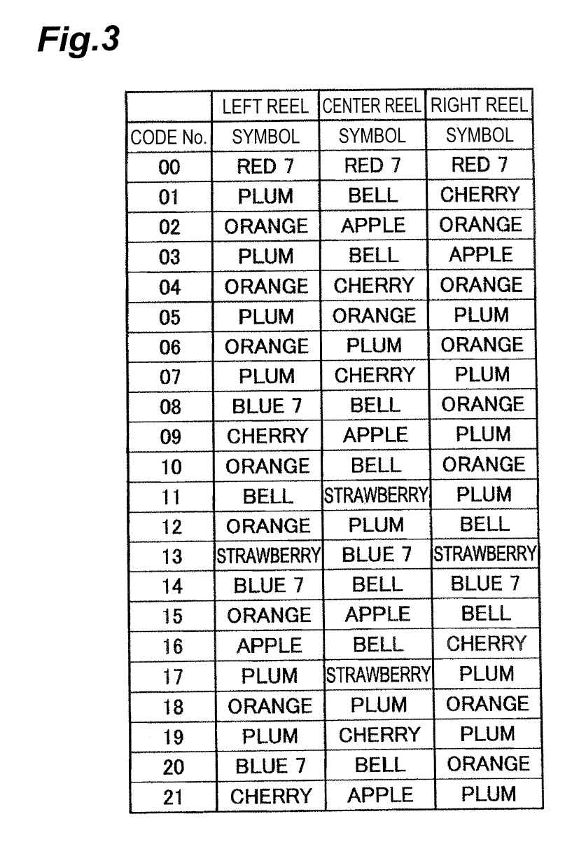

The slot machine 1 according to the present embodiment comprises a cabinet 2, a top box 3 arranged on the upper side of the cabinet 2, and a main door 4 provided on the front of the cabinet 2. Inside the cabinet 2, three reels 5L, 5C, and 5R are provided rotatably. On the outer circumferential surface of each of the reels 5L, 5C, and 5R, symbol columns composed of 22 symbols (refer to FIG. 3) are drawn.

Further, on the front of the top box 3, an upper image display panel 7 is provided. Here, the upper image display panel 7 is a so-called duel-view liquid crystal capable of simultaneously displaying a first image (a game image relating to a game in the present embodiment) that can be recognized visually in a first viewing angle direction including a frontal direction of the slot machine 1 and a second image (for example, a history image relating to the game history in the present embodiment) that can be recognized visually from a second viewing angle direction different from the first viewing angle direction. In the examples to be described later, the upper image display panel 7 displays, as the second image, the history image relating to the game history (history information), the explanatory image relating to the description of the game in progress (description of the game based on the lottery result), or the notification image (notification information) notifying the result of the lottery (for example, the possibility of winning an award) of the internal lottery of a base game before the reels 5L, 5C, and 5R come to a stop. Details of the history image, explanatory image, and notification image will be described later.

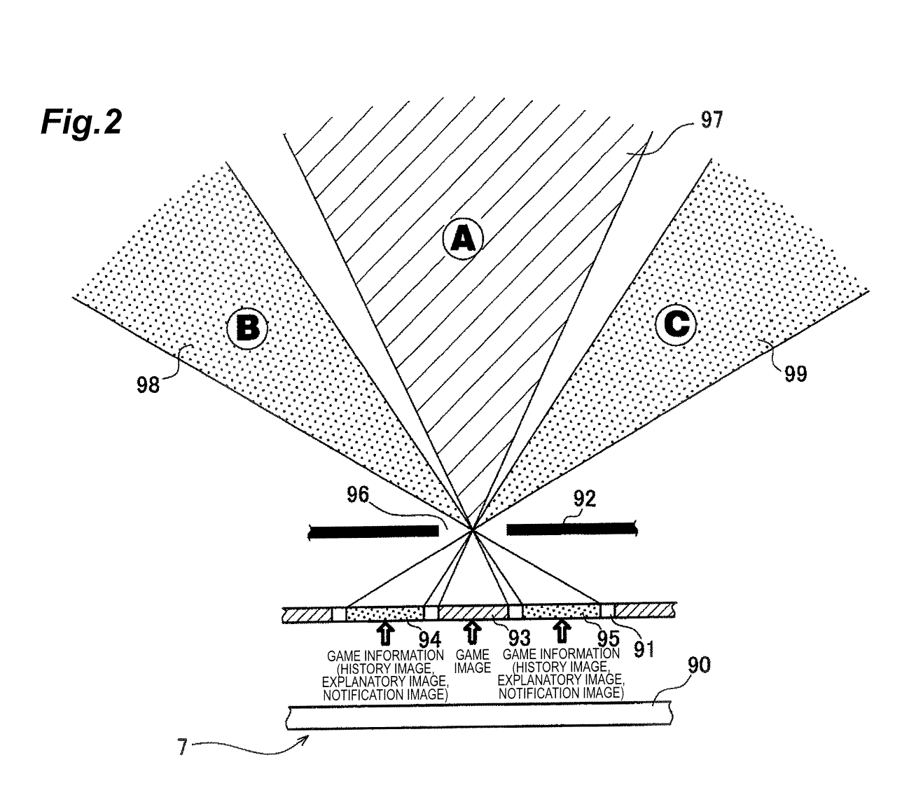

The principle of the duel-view liquid crystal is briefly described below using FIG. 2. FIG. 2 is a plan view schematically showing the structure of the upper image display panel 7.

As shown in FIG. 2, the upper image display panel 7 is constituted by a backlight 90, a pixelated image display layer 91, and a parallax barrier 92.

The backlight 90 is a light source for illuminating the upper image display panel 7 from the rear and constituted by combining a cold cathode fluorescent lamp and a light guide plate.

The pixelated image display layer 91 is a liquid crystal layer arranged between substrates, not shown, and in which a number of pixels are arranged in rows and columns. In particular, in the present embodiment, a game image to be displayed to a player “A” who plays a game with the slot machine 1 is displayed in a pixel column 93, game information (for example, a history image, explanatory image, notification image, etc., to be described later) to be displayed to a player “C” situated on the right-hand side of the slot machine 1 is displayed in a next pixel column 94, and game information to be displayed to a player “B” situated on the left-hand side of the slot machine 1 is displayed in a next pixel column 95. Then, repeatedly arranging the above-mentioned pixel column 93, pixel column 94, and pixel column 95 in order constitutes the pixelated image display layer 91 according to the present embodiment. In addition, in the present embodiment, the image to be displayed in the pixel column 94 and that in the pixel column 95 are the same, however, images different from each other may be displayed.

The parallax barrier 92 is a screen having a plurality of vertical translucent slits 96 separated by opaque areas (in FIG. 2, only one of the plurality of the translucent slits 96 is shown).

Then, the light from the backlight 90 having transmitted through the pixel column 93 of the pixelated image display layer 91 reaches the player “A” situated in a first viewing angle direction 97 including the frontal direction of the slot machine 1 via the plurality of the translucent slits 96, and allows the player A to visually recognize the game image about the game with the slot machine 1 displayed on the upper image display panel 7. On the other hand, the light from the backlight 90 having transmitted through the pixel column 95 reaches the player “B” situated in a second viewing angle direction 98 via the plurality of the translucent slits 96, and allows the player “B” to visually recognize the game information (for example, a history image about the game history, an explanatory image based on the progress of the game, notification image notifying the result of the internal lottery, etc.) of the slot machine 1 displayed on the upper image display panel 7. Further, the light from the backlight 90 having transmitted through the pixel column 94 reaches the player “C” situated in a third viewing angle direction 99 via the plurality of the translucent slits 96, and allows the player “C” to visually recognize the game information of the slot machine 1 displayed on the upper image display panel 7.

As described above, with the slot machine 1 according to the present embodiment, the game image that can be recognized visually from the first viewing angle direction 97, which is the viewing angle direction for the player “A” who plays the game with the slot machine 1, and the game information that can be recognized visually from the second viewing angle direction 98 and the third viewing angle direction 99, which are the viewing angle directions for the player “B” and the player “C” situated around the slot machine 1 can be simultaneously displayed on the same screen. In addition, with the slot machine 1 according to the present embodiment, the game image and the game information can be displayed on the same screen with different timings.

On the other hand, in front of each of the reels 5L, 5C, and 5R on the main door 4, a lower image display panel 6 is provided. Here, the lower image display panel 6 is constituted by a publicly known transparent liquid crystal panel and makes it possible for the symbols drawn on each of the reels 5L, 5C, and 5R to be recognized visually by bringing display windows 10L, 10C, and 10R into a transmission state during the base game. On the other hand, during the bonus game, it displays a predetermined bonus screen by bringing the display windows 10L, 10C, and 10R into a non-transmission state.

Further, on the front of the lower image display panel 6, a touch panel 11 is provided, thereby it is possible for a player to input various directions by operating the touch panel 11.

Further, the lower image display panel 6 is provided with a number-of-credits display portion 8 and a number-of-payouts display portion 9. On the number-of-credits display portion 8, the number of credits currently possessed by the player is displayed. On the number-of-payouts display portion 9, the amount of payout given when the combination of symbols having come to a stop to be displayed on a winning line L is a predetermined combination or the amount of payout obtained from the bonus game is displayed as a number of payouts.

Further, on the lower image display panel 6, the three display windows 10L, 10C, and 10R the backside of which can be recognized visually are formed and the symbols drawn on the outer circumferential surface of each of the reels 5L, 5C, and 5R are displayed in threes, respectively, via each of the display windows 10L, 10C, and 10R. Further, on the lower image display panel 6, the single winning line L horizontally crossing the three display windows 10L, 10C, and 10R is formed. The winning line L defines a combination of symbols. Then, when a combination of symbols having come to a stop to be displayed on the winning line L is a predetermined combination, an amount of payout in accordance with the combination and the number of bet credits (number of bets) is provided.

Below the lower image display panel 6, a control panel 20 on which a plurality of buttons with which a player inputs directions relating to the progress of a game are arranged, a coin insertion slot 21 for accepting a coin, which is a game medium, into the cabinet 2, and a bill validator 22 are provided.

On the control panel 20, a spin button 13, a change button 14, a CASHOUT button 15, a 1-BET button 16, a maximum BET button 17, and a cancel button 18 are provided. The spin button 13 is an operation means for inputting a direction to start the rotation of the reels 5L, 5C, and 5R. The change button 14 is an operation means used when requesting money exchange to the crew of a gaming facility. The CASHOUT button is an operation means for inputting a direction to pay out coins (one credit corresponds to one coin) in accordance with the number of credits possessed by a player onto a coin tray 24 from a coin payout opening 23 or a direction to pay out by a bar-coded ticket 25 to be described later.

The 1-BET button 16 is an operation means for accepting a direction to bet one credit on a game among the credits possessed by a player. The maximum BET button 17 is an operation means for accepting a direction to bet the maximum number of credits that can be bet on a single game (50 credits in the present embodiment) among the credits possessed by a player. The cancel button 18 is an operation means for preventing the game information (specifically, the notification image) of, such as the internal lottery result, from being displayed on the upper image display panel 7.

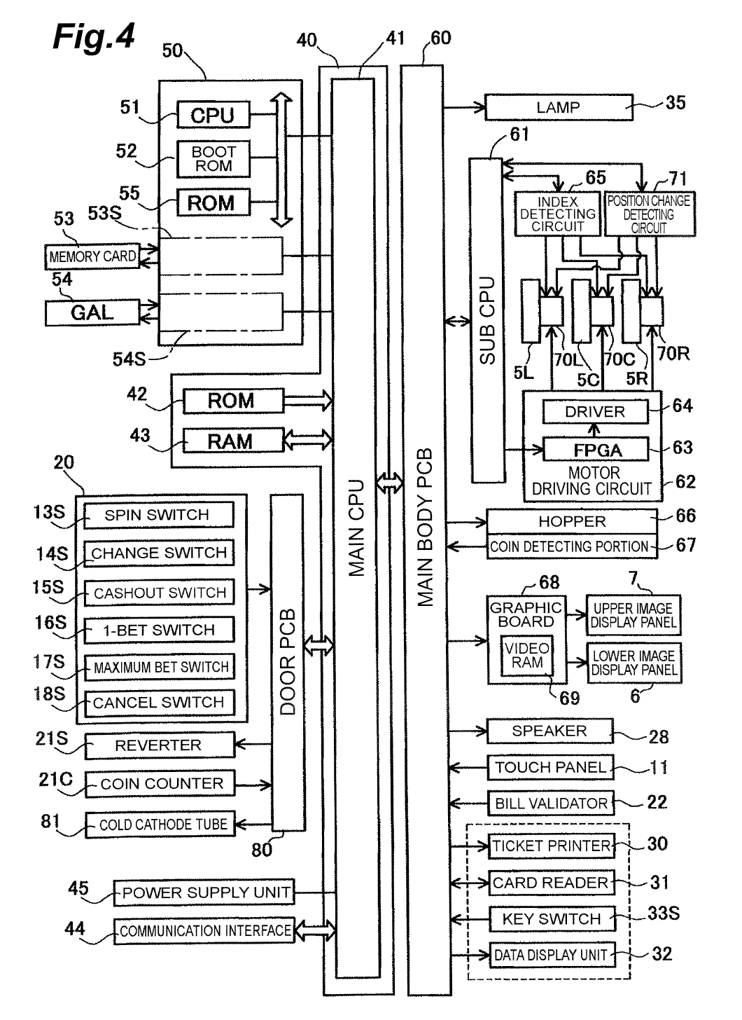

Here, the slot machine 1 according to the present invention displays the lottery result of the internal lottery of a base game as the game information (specifically, the notification image) on the upper image display panel 7 before the reels 5L, 5C, and 5R come to a stop to be displayed. However, if the cancel button 18 is pressed down by the player, a main CPU 41 (refer to FIG. 4) controls so that the lottery result of the internal lottery is not displayed as the notification image (that is, when the cancel button 18 is pressed down, other players therearound are not notified of the lottery result before the reels 5L, 5C, and 5R come to a stop to be displayed).

Incidentally, in the slot machine 1, the cancel button 18 may be omitted when the notification image of, such as the internal lottery result etc., is not displayed on the upper image display panel 7.

Inside the coin insertion slot 21, a reverter 21S and a coin counter 21C (refer to FIG. 4) are provided. Then, validity of the coin inserted from the coin insertion slot 21 is checked by the reverter 21S and coins other than legitimate ones are ejected from the coin payout opening 23. In addition, the accepted legitimate coin is detected and the number of the coins is counted by the coin counter 21C.

The bill validator 22 checks validity of a bill and accepts the legitimate bill into the cabinet 2. Then, the bill inserted into the cabinet 2 is converted into the number of coins and the credit corresponding to the converted number of coins is added to the credits possessed by the player. The bill validator 22 is configured to be capable of reading the bar-coded ticket 25 to be described later. On the lower front of the main door 4, that is, below the control panel 20, a berry glass 26 on which the character of the slot machine 1 etc. is drawn is provided.

In the slot machine 1 according to the present embodiment, coins, bills, or electronic valuable information (credit) corresponding thereto are used as game media. However, the game media applicable to the present invention are not limited to these and, for example, medals, tokens, electronic money, and tickets may be included.

On the lower side of the upper image display panel 7, a ticket printer 30, a card reader 31, a data display unit 32, and a keypad 33 are provided (refer to FIG. 1 and FIG. 4).

Here, the ticket printer 30 is a printing device that prints bar code on the ticket, which is coded data, such as the number of credits, date/time, and the identification number of the slot machine 1, and outputs the ticket as the bar-coded ticket 25. The player can play games on another slot machine by causing the slot machine to read the bar-coded ticket 25, or can use the bar-coded ticket 25 for procedures at a predetermined place in the gaming facility.

The card reader 31 reads and writes data from and to a smart card. The smart card is a card carried by the player and, for example, stores data about the history of the games played by the player.

The data display unit 32 includes a fluorescent display, and displays data read by the card reader 31 or data entered by the player using the keypad 33, for example. In addition, the keypad 33 is used to input directions or data relating to ticket issuance etc. Further, on the top surface of the top box 3, a lamp 35 is provided. The lamp 35 lights up in a predetermined lit state when the crew in the gaming facility is called, such as when an error occurs in the slot machine 1.

Next, the symbols drawn on the outer circumferential surface of each of the reels 5L, 5C, and 5R and variably displayed while being scrolled through the display windows 10L, 10C, and 10R of the lower image display panel 6 during the game will be described based on FIG. 3. FIG. 3 is a schematic diagram showing columns of symbols drawn on the outer circumferential surface of each of the reels 5L, 5C, and 5R.

On the respective outer circumferential surfaces of the left reel 5L, the center reel 5C, and the right reel 5R, 22 symbols are drawn, respectively. Each symbol column is composed of a combination of the “RED7”, “BLUE7”, “BELL”, “CHERRY”, “STRAWERRY”, “PLUM”, “ORANGE”, and “APPLE” symbols. As shown in FIG. 3, on each of the reels 5L, 5C, and 5R, predetermined kinds of symbols are arranged in a predetermined order, respectively.

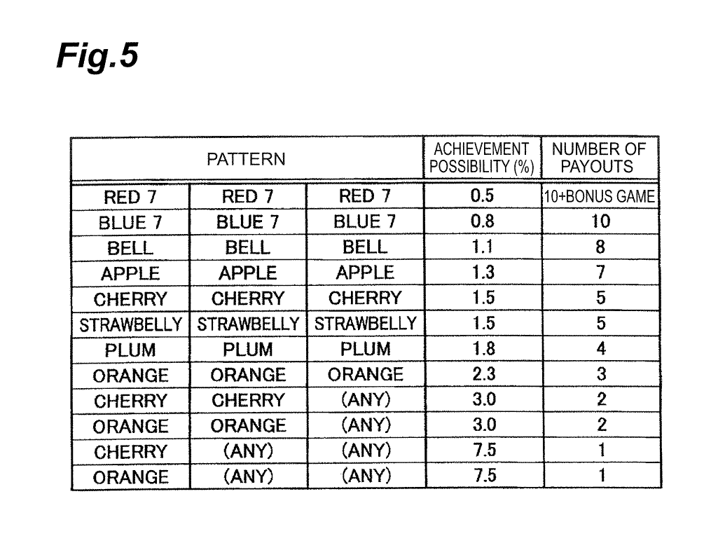

When three symbols of the “BLUE7”, “CHERRY”, “STRAWBERRY”, “PLUM”, “ORANGE”, or “APPLE” come to a stop to be displayed on the winning line L, a predetermined amount of payout is provided to the player (refer to FIG. 5). In addition, as to the “CHERRY” and “ORANGE”, even in the case where one or two of each symbol come to a stop to be displayed on the winning line L, an amount of payout determined in advance is provided to the player in accordance with the number of symbols (refer to FIG. 5).

In the game played with the slot machine according to a first example of the present embodiment to be described later, when the three “RED7” symbols come to a stop to be displayed on the winning line L, a predetermined amount of payout is provided to the player, and the game shifts to the bonus game. Here, the bonus game played with the slot machine 1 according to the first example is a selection type bonus game, in which a plurality of choices are displayed on the lower image display panel 6, and payout is provided to the player based on the selection result by the player. The details of the bonus game in the first example are omitted.

In addition, in the game played with slot machines according to a second example and a third example of the present embodiment to be described later, when the three “RED7” symbols come to a stop to be displayed on the winning line L, a predetermined amount of payout is provided to the player, and the game shifts to the bonus game. Here, the game played with the slot machines 1 according to the second example and the third example is composed of two gaming modes, that is, the base game and the bonus game, and in the base game, a combination of specific symbols is caused to come to a stop on the winning line L using the reels 5L, 5C, and 5R. On the other hand, in the bonus game, three treasure chests, which are choices, are displayed on the lower image display panel 6 and payout is provided, the payout being associated with the treasure chest selected by the player among the displayed treasure chests. The details of the bonus game in the second example and the third example are omitted.

Then, after the number of bets is fixed by the operation of the 1-BET button 16 or the maximum BET button 17, the column of symbols drawn on each of the reels 5L, 5C, and 5R shown in FIG. 3 is scrolled and displayed in the vertical direction from the top to the bottom in the display windows 10L, 10C, and 10R when there is an input from the spin button 13 accompanying the rotation of the reels 5L, 5C, and 5R. Then, after a lapse of a predetermined time, the symbols come to a stop to be displayed in the display windows 10L, 10C, and 10R accompanying the stop of the reels 5L, 5C, and 5R. Further, various patterns (refer to FIG. 5) are determined in advance based on each combination of symbols and when a combination of symbols corresponding to a pattern comes to a stop on the winning line L, an amount of payout in accordance with the pattern having come to a stop is provided to the player.

Next, a configuration of a control system of the slot machine 1 according to the present embodiment will be described based on FIG. 4. FIG. 4 is a block diagram schematically showing the control system of the slot machine 1 according to the present embodiment.

As shown in FIG. 4, the control system of the slot machine 1 is basically composed of a motherboard 40 and a gaming board 50.

First, the gaming board 50 is described. The gaming board 50 includes a CPU 51, a ROM 55, and a boot ROM 52 connected to one another by an internal bus, a card slot 53S corresponding to a memory card 53, and an IC socket 54S corresponding to a GAL (Generic Array Logic) 54.

The memory card 53 is composed of a nonvolatile memory and is a recording medium in which a game program and a game system program (hereinafter, referred to as game programs etc.) are recorded. The game program recorded in the memory card 53 includes a lottery program. The lottery program is a program for determining a symbol (code No. corresponding to the symbol) of each of the reels 5L, 5C, and 5R caused to come to a stop to be displayed on the winning line L. The lottery program includes symbol weighting data corresponding to each of a plurality of kinds of payout rates (for example, 80%, 84%, and 88%), respectively. The symbol weighting data is data showing a correspondence between the code No. of each symbol (refer to FIG. 3) and one or more random number values belonging to a predetermined numerical range (0 to 255). In other words, a symbol code No. is associated with one or more random number values and when a random number is extracted by a lottery, the symbol specified by the random number value is caused to come to a stop to be displayed.

In addition, the payout rate is determined based on the payout rate setting data output from the GAL 54 and a lottery is executed based on the symbol weighting data corresponding to the payout rate.

The card slot 53S is constructed so that the memory card 53 can be inserted thereinto and removed therefrom and is connected to the motherboard 40 by an IDE bus. Consequently, rewriting the game programs etc. stored in the memory card 53 can change the kinds and contents of the games played with the slot machine 1. Alternatively, replacing the memory card 53 with another in which other game programs etc. are stored can change the kinds and contents of the games played with the slot machine 1.

The game program also includes programs relating to the progress of games, image data and sound data output during a game, image data and sound data as notification data, etc.

The GAL 54 is a kind of PLD having an OR-fixed type array structure. The GAL 54 includes a plurality of input ports and output ports and when predetermined data is input to the input port, data corresponding to the data is output from the output port. The data output from the output port is the payout rate setting data described above.

Further, the IC socket 54S is constructed so that the GAL 54 can be attached thereto and detached therefrom, and is connected to the motherboard 40 via a PCI bus. Consequently, rewriting the GAL 54 or exchanging the GAL 54 itself with another can change the payout rate setting data output from the GAL 54.

The CPU 51, the ROM 55, and the boot ROM 52 connected to one another by the internal bus are connected to the motherboard 40 via the PCI bus. The PCI bus performs signal transmission between the motherboard 40 and the gaming board 50 and supplies electric power from the motherboard 40 to the gaming board 50. The ROM 55 stores country identification information and an authentication program. The boot ROM 52 stores a preliminary authentication program and programs (boot code) etc. with which the CPU 51 starts the preliminary authentication program.

The authentication program is a program for authenticating the game program etc. (alteration check program). The authentication program is written in accordance with the procedure of alteration check of the game program etc. for which an authenticating read process is executed. The preliminary authentication program is a program for authenticating the authentication program described above, and is written in accordance with the procedure of alteration check of the authentication program for which an authentication process is executed.

Next, the motherboard 40 is described. The motherboard 40 is configured using a commercial general-purpose motherboard (a print wiring board mounting basic parts of a personal computer), including the main CPU 41, a ROM 42, a RAM 43, and a communication interface 44.

In the slot machine according to the first example of the present embodiment to be described later, the ROM 42 is composed of a memory device, such as a flash memory, and stores programs such as the BIOS executed by the main CPU 41 and the permanent data such as the payout table (refer to FIG. 5). When the main CPU 41 executes the BIOS, the predetermined initialization process of the peripheral devices is executed and the read process of the game program etc. stored in the memory card 53 is started via the gaming board 50.

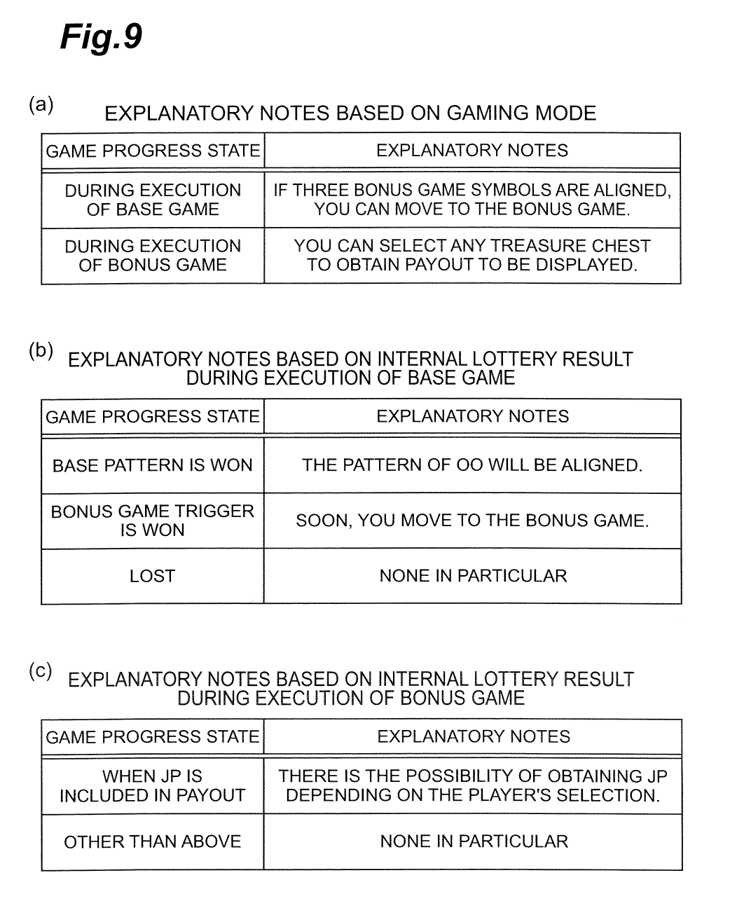

In the slot machine according to the second example and the third example of the present embodiment to be described later, the ROM 42 is composed of a memory device, such as a flash memory, and stores programs such as the BIOS executed by the main CPU 41 and the permanent data such as the lottery table of the base game and the bonus game, the payout table (refer to FIG. 5), the explanatory notes (refer to FIG. 9) associated with various game states of the slot machine 1, etc. Similar to the case of the first example, when the BIOS is executed by the main CPU 41, a predetermined initialization process of the peripheral devices is executed and a read process of the game programs etc. stored in the memory card 53 is started via the gaming board 50.

The RAM 43 stores data and programs used when the main CPU 41 operates. Further, the RAM 43 can store various programs, such as the authentication program read via the gaming board 50, the game programs, etc., and various pieces of information such as the number of credits currently possessed by a player, the game history (for example, the number of times of execution of the game, the number of times of occurrence of the bonus game, the number of payouts, etc.) of the game played with the slot machine 1, etc.

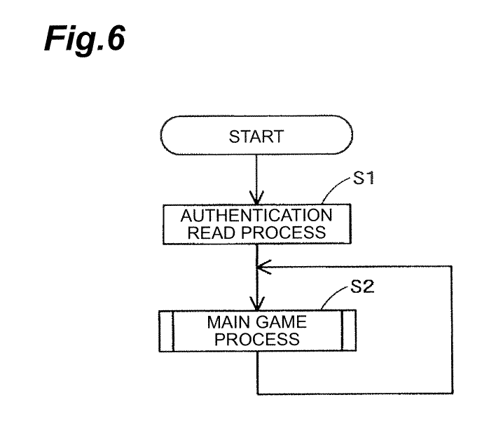

The communication interface 44 is a communication device for performing communication with the server etc. installed in the gaming facility via communication lines. The slot machine 1 performs communication of bet information in the main game process to be described later (refer to S2 in FIG. 6), the lottery result of a base pattern lottery process, etc., with the server etc. via the communication interface 44.

To the motherboard 40, a main body PCB 60 and a door PCB 80 to be described later are connected via the USB, respectively. Further, to the motherboard 40, a power supply unit 45 is connected. When electric power is supplied from the power supply unit 45 to the motherboard 40, the main CPU 41 of the motherboard 40 is activated. Furthermore, electric power is supplied to the gaming board 50 via the PCI bus and the CPU 51 is activated.

Devices and units that generate input signals to be fed to the main CPU 41, as well as devices and units whose operation is controlled by the control signal from the main CPU 41 are connected to the main body PCB 60 and the door PCB 80. The main CPU 41 executes the game programs etc. stored in the RAM 43 based on the input signal fed to the main CPU 41. Then, by executing a predetermined arithmetic process, the main CPU 41 stores the result of the arithmetic process into the RAM 43 and executes a control process for the respective devices and units.

To the main body PCB 60, the lamp 35, a sub CPU 61, a hopper 66, a coin detecting unit 67, a graphic board 68, a speaker 28, the touch panel 11, the bill validator 22, the ticket printer 30, the card reader 31, a key switch 38S, and the data display unit 32 are connected.

Here, the touch panel 11 is arranged on the front of the lower image display panel 6 and identifies the coordinates and position of a part touched by the player and is capable of determining which part the player touches based on the identified coordinate position information and further which direction the touched part moves in.

The sub CPU 61 controls the rotation and stop of the reels 5L, 5C, and 5R. To the sub CPU 61, a motor driving circuit 62 including an FPGA (Field Programmable Gate Array) 63 and a driver 64 is connected. The FPGA 63 is an electronic circuit, such as a programmable LSI, and functions as a control circuit of stepping motors 70L, 70C, and 70R. The driver 64 functions as an amplifier circuit of pulses to be input to the stepping motors 70L, 70C, and 70R. To the motor driving circuit 62, the stepping motors 70L, 70C, and 70R, which are 1-2 phase excitation-system stepping motors that rotate each of the reels 5L, 5C, and 5R is connected.

To the sub CPU 61, an index detecting circuit 65 and a position change detecting circuit 71 are connected. The index detecting circuit 65 detects the position (for example, the reference point) of the reels 5L, 5C, and 5R being rotated and detects detuning of the reels 5L, 5C, and 5R.

The position change detecting circuit 71 detects the change in the stop position of the reels 5L, 5C, and 5R after the rotation of the reels 5L, 5C, and 5R stops. For example, the position change detecting circuit 71 detects the change in the stop position of the reels 5L, 5C, and 5R when the player has forcedly changed the stop position of a combination of symbols, which is actually not a winning combination of symbols, so that the combination of symbols will be a winning combination.

The hopper 66 is provided inside the cabinet 2 and pays out a predetermined number of coins from the coin payout opening 23 onto the coin tray 24 based on the control signal from the main CPU 41. The coin detecting unit 67 is provided inside the coin payout opening 23 and outputs the input signal to the main CPU 41 when detecting that a predetermined number of coins have been paid out from the coin payout opening 23.

The graphic board 68 controls the image display on the upper image display panel 7 and the lower image display panel 6 based on the control signal from the main CPU 41. For example, the number-of credits-display portion 8 displays the number of credits possessed by the player and stored in the RAM 43. The number-of payouts-display portion 9 displays the number of coins paid out for payout.

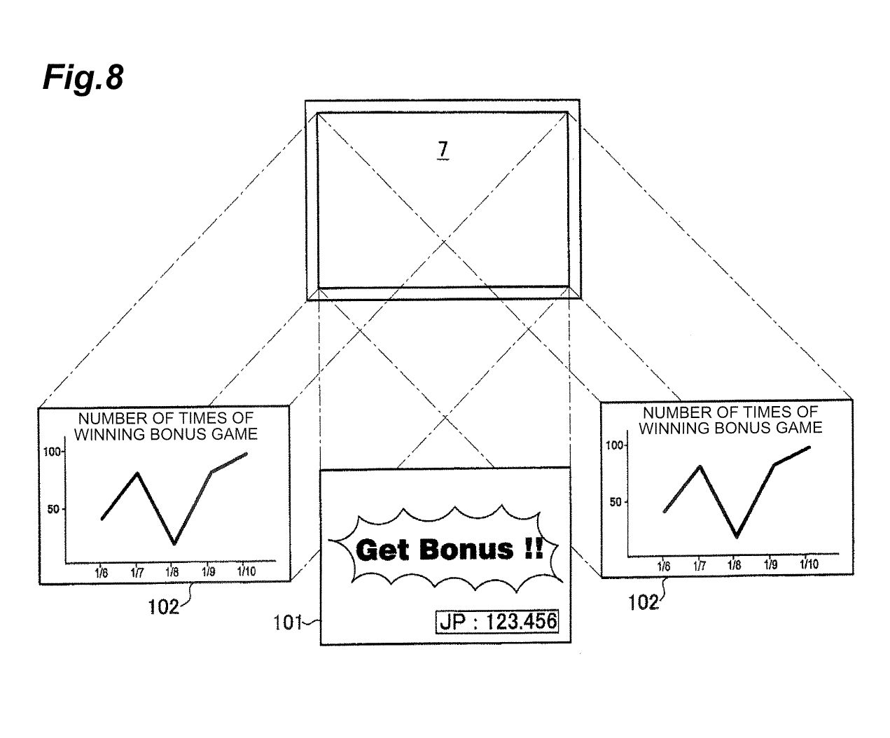

The slot machine according to the first example of the present embodiment to be described later is controlled so that the upper image display panel 7 displays a game image 101 (refer to FIG. 8) relating to the effect executed in accordance with the symbol variation of the reels 5L, 5C, and 5R for the player in the first viewing angle direction 97 (refer to FIG. 2), while displaying a history image 102 (refer to FIG. 8) relating to the number of times of occurrence of the bonus game for the players in the second viewing angle direction 98 and the third viewing angle direction 99 (refer to FIG. 2).

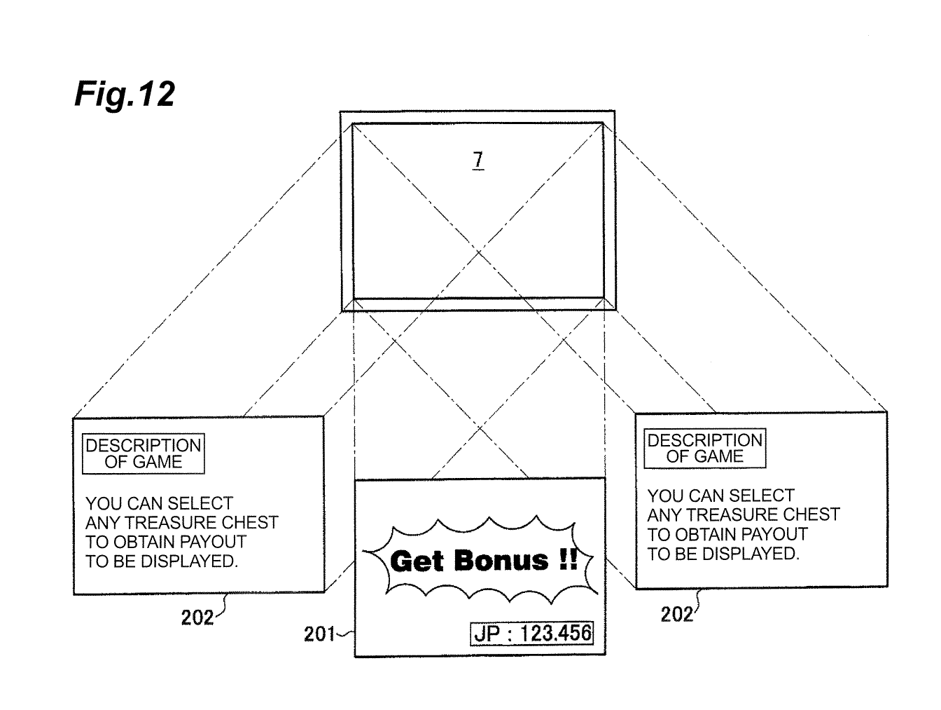

In addition, the slot machine according to the second example of the present embodiment to be described later is controlled so that the upper image display panel 7 displays a game image 201 (refer to FIG. 12) relating to the effect executed in accordance with the symbol variation of the reels 5L, 5C, and 5R for the player in the first viewing angle direction 97 (refer to FIG. 2), while displaying an description in accordance with the progress of the current game (the internal lottery result or the current gaming mode) in an explanatory image 202 (refer to FIG. 12) for the players in the second viewing angle direction 98 and the third viewing angle direction 99 (refer to FIG. 2).

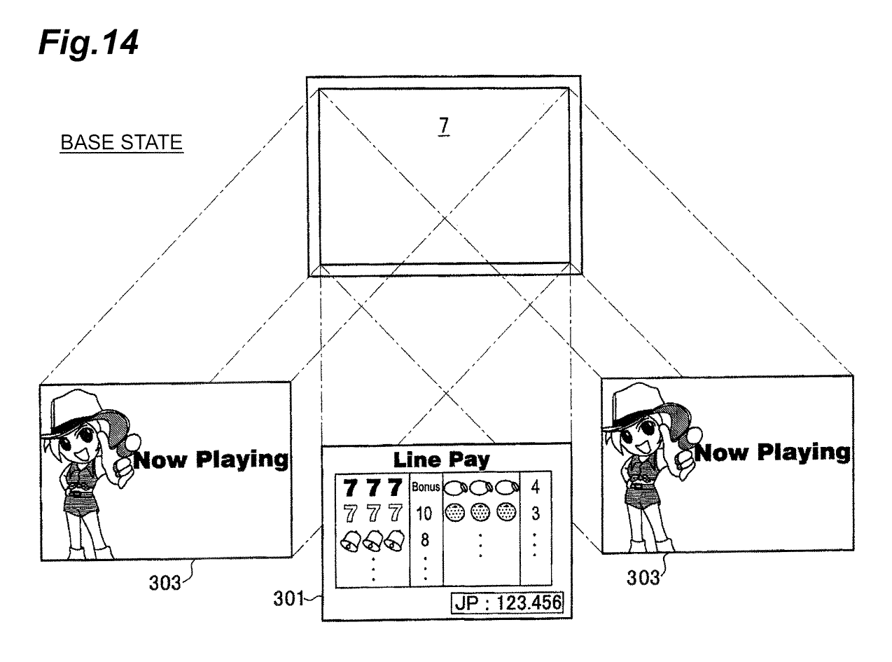

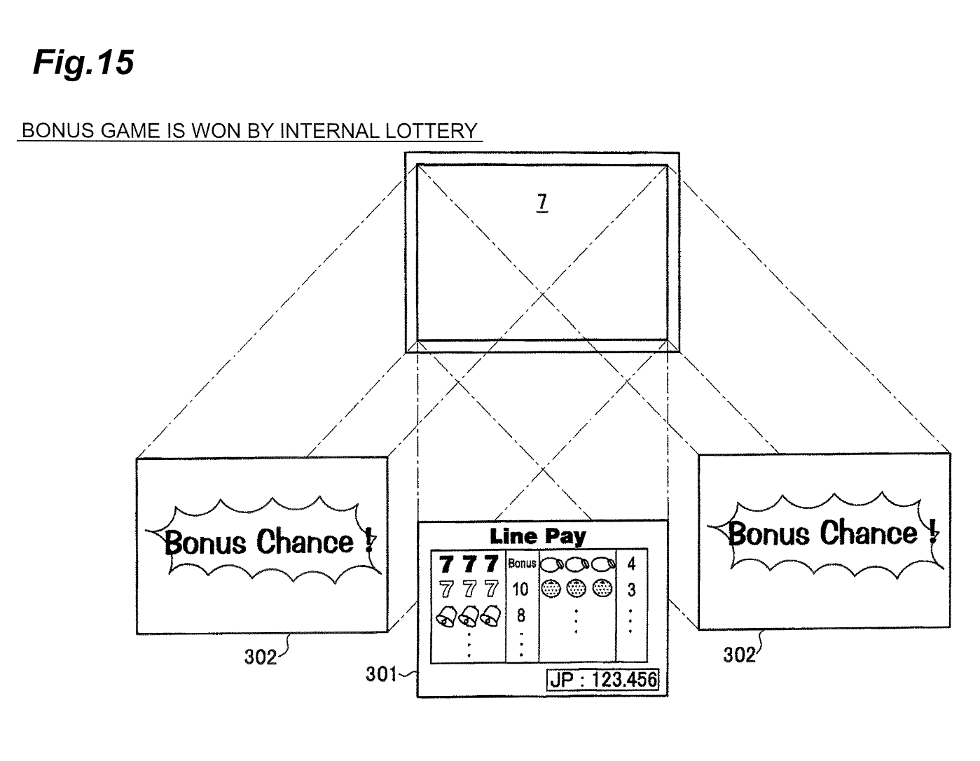

In addition, the slot machine according to the third example of the present embodiment to be described later is controlled so that the upper image display panel 7 displays a game image 301 (refer to FIG. 14, FIG. 15) relating to the game contents in accordance with the symbol variation of the reels 5L, 5C, and 5R for the player in the first viewing angle direction 97 (refer to FIG. 2). On the other hand, the slot machine is controlled so that the upper image display panel 7 displays a notification image 302 (refer to FIG. 15) notifying the internal lottery result of the base game before the reels 5L, 5C, and 5R come to a stop to be displayed or a during-game image 303 (refer to FIG. 14) notifying that another player is playing with the slot machine 1 for the players in the second viewing angle direction 98 and the third viewing angle direction 99 (refer to FIG. 2).

Here, the graphic board 68 includes a VDP (Video Display Processor) for generating image data based on the control signal from the main CPU 41, a video RAM 69 for temporarily storing image data generated by the VDP, etc. The image data used when the image data is generated by the VDP is included in the game program.

The bill validator 22 checks validity of the bill or the bar-coded ticket 25 and accepts the legitimate bill or bar-coded ticket 25 into the cabinet 2. When accepting the legitimate bill, the bill validator 22 outputs an input signal to the main CPU 41 based on the amount of the bill. Further, the bill validator 22 outputs an input signal to the main CPU 41 based on the number of coins recorded on the legitimate bar-coded ticket 25.

The ticket printer 30 prints the bar code on the ticket, which is coded data, such as the number of credits, stored in the RAM 43 based on the control signal output from the main CPU 41 and outputs as the bar-coded ticket 25.

In addition, the card reader 31 reads data from the smart card and transmits the data to the main CPU 41 or writes the data into the smart card based on the control signal from the main CPU 41. The key switch 33S is provided on the keypad 33 and outputs a predetermined input signal to the main CPU 41 when a player operates the keypad 33. The data display unit 32 displays the data read by the card reader 31 or the data input by the player via the keypad 33 based on the control signal output from the main CPU 41.

On the other hand, the control panel 20, the reverter 21S, the coin counter 21C, and a cold cathode tube 81 are connected to the door PCB 80. On the control panel 20, a spin switch 13S corresponding to the spin button 13, a change switch 14S corresponding to the change button 14, a CASHOUT switch 15S corresponding to the CASHOUT button 15, a 1-BET switch 16S corresponding to the 1-BET button 16, a maximum BET switch 17S corresponding to the maximum BET button 17, and a cancel switch 18S corresponding to the cancel button 18 are provided. The respective switches output, when the player operates their corresponding buttons, the input signal to the main CPU 41. When the cancel button 18 is omitted in the slot machine 1, the cancel switch 18S on the control panel 20 is also omitted.

The coin counter 21C is provided inside the coin insertion slot 21 and checks validity of the coin inserted into the coin insertion slot 21 by the player. Coins other than the legitimate one are ejected from the coin payout opening 23 and when the legitimate coin is detected, the coin counter 21C outputs an input signal to the main CPU 41.

The reverter 21S operates based on the control signal output from the main CPU 41 and sorts the coins recognized as legitimate ones by the coin counter 21C to either the cashbox (not shown) or the hopper 66 provided inside the slot machine 1. The cold cathode tube 81 is provided on the backside of the lower image display panel 6 and the upper image display panel 7 and lights up based on the control signal from the main CPU 41 and functions as a backlight.

Next, winning patterns and their payout when the base game is played using the reels 5L, 5C, and 5R with the slot machine 1 of the present embodiment will be described based on FIG. 5. FIG. 5 shows a payout table showing winning patterns and the achievement possibility and payout of each pattern when a game is played using the reels 5L, 5C, and 5R.

Here, the payout shown in FIG. 5 indicates payout when the number of bets is “1”. Consequently, when the number of bets is “1”, the value of the payout shown in FIG. 5 is added to the credits, and when the number of bets is “2” or more, the value of the payout shown in FIG. 5 multiplied by the number of bets is added to the credits.

The achievement possibility of each pattern shown in FIG. 5 shows the case where the payout rate in games other than the bonus game is 88%. The achievement possibility shown in the figure shows the possibility that the pattern is achieved when the code No. of each of the reels 5L, 5C, and 5R is determined based on the three random number values by referring to the symbol weighting data. In other words, it is not that the random number value is associated with each pattern.

For example, the achievement possibility of the bonus game trigger is 0.5%. When the bonus game trigger is won, the three “RED7” symbols come to a stop to be displayed on the winning line and ten credits are paid out as payout and the bonus game is invoked.

The achievement possibility of “BLUE7” is 0.8%. When this pattern is achieved, the three “BLUE7” symbols come to a stop to be displayed on the winning line and ten credits per bet are paid out as payout.

The achievement possibility of “BELL” is 1.1%. When this pattern is achieved, the three “BELL” symbols come to a stop to be displayed on the winning line L and eight credits per bet are paid out as payout.

Similarly, the achievement possibility and the number of coins to be paid out are set for each combination shown in FIG. 5. However, when a combination of symbols that corresponds to none of the combinations of the winning pattern shown in FIG. 5 comes to a stop to be displayed, the combination is lost and payout of credits is not made.

Next, the details of the game process in the slot machine according to the present embodiment will be described based on examples. It is needless to say that the present invention is not limited to these examples and arbitrary and preferable modifications and changes can be made within the scope of the object of the present invention.

### FIRST EXAMPLE (EXAMPLE 1)

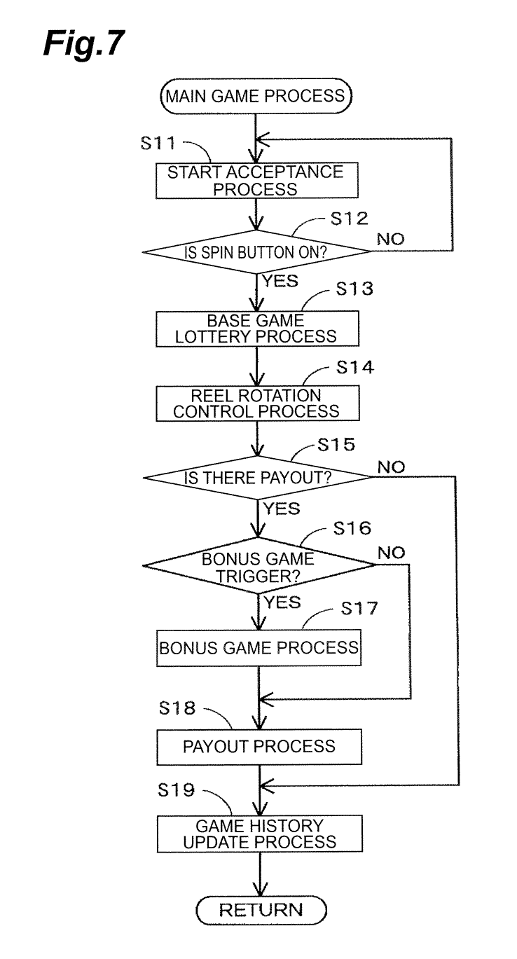

First, the main control program executed in the slot machine according to a first example of the present embodiment will be described in detail with reference to drawings (especially, FIGS. 7 and 8). FIG. 6 is a flow chart of the main control program, which is also applicable to the second and third examples to be described later.

It is assumed that the memory card 53 has already been inserted into the card slot 53S of the gaming board 50 and the GAL 54 is attached to the IC socket 54S.

First, when the power supply switch is turned on (the turning on of the power supply) in the power supply unit 45, the motherboard 40 and the gaming board 50 are activated, respectively, and an authentication read process in step (hereinafter, abbreviated to S) 1 is executed. In this authentication read process, the motherboard 40 and the gaming board 50 execute the individual processes in parallel, respectively.

In other words, on the gaming board 50, the CPU 51 reads the preliminary authentication program stored in the boot ROM 52 and executes a preliminary authentication in accordance with the read preliminary authentication program to check and prove in advance, before being taken into the motherboard 40, that the authentication program has not been altered.

On the other hand, on the motherboard 40, the main CPU 41 executes the BIOS stored in the ROM 42 and decompresses the compressed data embedded in the BIOS into the RAM 43 and executes the BIOS that has been decompressed into the RAM 43 and executes diagnosis and initialization of various peripheral units.

Then, the main CPU 41 reads the authentication program stored in the ROM 55 and executes authentication to check and prove that the game programs etc. stored in the memory card 53 inserted into the card slot 53S have not been altered. When the authentication process is completed normally, the main CPU 41 writes the game programs etc. for which the authentication has been executed (the authenticated game programs) into the RAM 43 and acquires the payout rate setting data and country identification information.

After executing the above-described processes, the main CPU 41 completes the authentication read process.

Then, in S2, the main CPU 41 reads the game programs etc. authenticated in the authentication read process in S1 mentioned above sequentially from the RAM 43 and executes them and executes a main game process. By the execution of the main game process, the game in the slot machine 1 according to the present example is played. Then, the main game process is executed repeatedly while the power is being supplied to the slot machine 1.

Here, when the main game process is executed in S2 mentioned above, the upper image display panel 7 is controlled so as to display the game image relating to the game with the slot machine 1 and the history image relating to the history of the game. Here, FIG. 8 shows an example of the game image 101 and the history image 102 displayed on the upper image display panel 7 in the main game process. The history image 102 shown in FIG. 8 is one piece of the game information based on the game process relating to the game controlled by a processor, such as the main CPU 41, that is, the history information relating to the history (game history) of the game process controlled by the processor.

More specifically, the slot machine 1 according to the present example creates the game image 101 relating to the game of the slot machine 1, such as the internal lottery result, an advance notice, etc., by the VDP of the graphic board 68 and stores the image in the video RAM 69. On the other hand, by reading the game history stored in the RAM 43, the slot machine 1 creates the history image 102 relating to the game history by the VDP of the graphic board 68 and stores the image in the video RAM 69.

As mentioned above, the upper image display panel 7 is configured by the duel-view liquid crystal and displays the game image 101 read from the video RAM 69 using the pixel column 93 of the pixelated image display layer 91 for the player situated in the first viewing angle direction 97 (refer to FIG. 2) including the frontal direction of the slot machine 1. FIG. 8 shows the game image 101 notifying the player that, when the bonus game has been won in particular, the bonus game has been won, displaying that the bonus game has been won together with the amount of JP (Jackpot). It may also be possible to display the payout table or the bonus game screen in the game image 101.

On the other hand, the upper image display panel 7 displays the history image 102 read from the video RAM 69 using the pixel columns 94 and 95 of the pixelated image display layer 91 for other players situated in the second viewing angle direction 98 and the third viewing angle direction 99 (refer to FIG. 2) different from the first viewing angle direction 97. FIG. 8 displays the history image 102 displaying in a graph the number of times of winning of the bonus game encompassing a plurality of days from five days ago until the current day in particular, and other players can easily grasp the state of the slot machine 1 by referring to the history image 102. It may also be possible to display in the history image 102 the number of times of winning of the bonus game on the current day for each time period. In addition, it may also be possible to display information, such as the number of times of the game, the number of payouts, the payout rate, etc., on the current day or during a plurality of days instead of the number of times of the bonus game as the game history displayed in the history image 102.

Next, the sub process of the main game process in S2 mentioned above will be described based on FIG. 7. FIG. 7 is a flow chart of the main game process program in the slot machine according to the present first example. Each program shown by the flow chart in FIG. 7 is stored in the ROM 42 or the RAM 43 included in the slot machine 1 and is executed by the main CPU 41.

First, as shown in FIG. 7, after executing the predetermined initial setting, the main CPU 41 executes the start acceptance process for setting the number of bets etc. for the insertion of coins and the winning line L in S11. At this time, in the start acceptance process, the player inserts coins and performs the bet operation using the 1-BET button 16 and the maximum BET button 17.

Next, in S12, the main CPU 41 determines whether or not there is an input from the spin button 13. Whether or not there is an input from the spin button 13 is determined based on whether or not the input signal from the spin switch 13S is received.

When there is no input from the spin button 13 (S12: NO), the process returns to the start acceptance process (S11) again. At this time, the operation, such as modification of the number of bets, is made possible. On the other hand, when there is an input from the spin button 13 (S12: YES), the main CPU 41 subtracts the number of bets set for the winning line L based on the operation of the 1-BET button 16 and the maximum BET button 17 from the number of possessed credits and stores it in the RAM 43 as bet information.

Next, in S13, the main CPU 41 executes the base game lottery process using the reels 5L, 5C, and 5R. Specifically, the main CPU 41 selects random number values corresponding to the three reels 5L, 5C, and 5R, respectively, within the numerical range of “0 to 255” by executing the random number generation program included in the lottery program stored in the RAM 43. Then, the main CPU 41 refers to the symbol weighting data in accordance with the payout rate setting data and determines the code No. of each of the reels 5L, 5C, and 5R (refer to FIG. 3) based on the three selected random number values. After storing the determined code No. of each of the reels 5L, 5C, and 5R in the RAM 43, the main CPU 41 proceeds to S14.

Here, since the code No. of each of the reels 5L, 5C, and 5R corresponds to the code No. of the symbol that comes to a stop to be displayed on the winning line L, the pattern of the game is determined by the main CPU 41 determining the code No. of each of the reels 5L, 5C, and 5R. For example, if the main CPU 41 determines the code No. of each of the reels 5L, 5C, and 5R as “00”, “00”, and “00”, it means that the CPU has determined the pattern as “RED7”. In this manner, by determining the code No. of each of the reels 5L, 5C, and 5R, the lottery relating to the base pattern (refer to FIG. 5) is executed.

Next, in S14, the main CPU 41 executes a reel rotation control process. The reel rotation control process is a process in which the rotation of each of the reels 5L, 5C, and 5R is stopped after the rotation of all of the reels 5L, 5C, and 5R is started so that a combination of the symbols determined in the base game lottery process (S13) comes to a stop to be displayed on the winning line L. This process is a process executed between the main CPU 41 and the sub CPU 61.

To describe specifically, in the reel rotation control process (S14), the main CPU 41 first transmits a start signal to start rotation of the reel to the sub CPU 61. The sub CPU 61, upon receipt of the start signal, executes the reel rotation process. In other words, the sub CPU 61 drives each of the stepping motors 70L, 70C, and 70R by the motor driving circuit 62 and the driver 64 to start the rotation of each of the reels 5L, 5C, and 5R.

Then, after transmitting the start signal, the main CPU 41 determines the effect pattern for one game (pattern such as display of an image on the lower image display panel 6, output of sound from the speaker 28, etc.) and starts the effect with the determined effect pattern.

After this, when predetermined stop timing of stopping the rotation of the reels 5L, 5C, and 5R is reached, the main CPU 41 transmits the code No. of the reel stored in the RAM 43 to the sub CPU 61. The sub CPU 61 executes the reel stop process based on the code No. of the reel. Due to this, the symbol corresponding to the lottery result comes to a stop to be displayed on the winning line L of each of the display windows 10L, 10C, and 10R.

Then, in S15, the main CPU 41 determines whether or not payout has been made in the slot machine 1. As a result, when any one of the patterns shown in FIG. 5 is achieved (S15: YES), the process proceeds to S16. On the other hand, when none of the patterns is achieved (S15: NO), the process proceeds to S19.

In S16, the main CPU 41 determines whether or not the bonus game trigger has been achieved in the base game. Specifically, it is determined that the bonus game trigger has been achieved when the combination of the “RED7” symbols comes to a stop to be displayed on the winning line L.

Then, when it is determined that the bonus game trigger has been achieved (S16: YES), the main CPU 41 executes the selection type bonus game process (S17) and then pays the payout obtained from the base game and the bonus game, respectively, to the player (S18). At this time, it is also possible to pay out as coins in accordance with the number of credits (one credit corresponds to one coin) by pressing down the CASHOUT button 15 and to pay out as the bar-coded ticket 25.

On the other hand, when it is determined that the bonus game trigger has not been achieved (S16: NO), the payout obtained from the base game is paid out to the player (S18).

Next, in S19, the game history stored in the RAM 43 is updated based on the game result of the game of this time. Then, the upper image display panel 7 is controlled so as to display the history image 102 based on the updated game history.

As described above, in the slot machine according to the present first example, the upper image display panel 7 is configured by the duel-view liquid crystal and for the player situated in the first viewing angle direction 97 (refer to FIG. 2) including the frontal direction of the slot machine 1, the game image 101 relating to the game of the slot machine 1 is displayed, and for other players situated in the second viewing angle direction 98 and the third viewing angle direction 99 (refer to FIG. 2) different from the first viewing angle direction 97, the history image 102 relating to the game history of the games played with the slot machine 1 is displayed, and therefore, the respective proper images can be simultaneously displayed to the player playing the game and other players by only one display means without the need to operate a switching switch etc. Consequently, useful information can easily be provided to other players who wish to play the game in the future without interfering with the player's game and thus the convenience of the player is improved.

In addition, since the first viewing angle direction 97 in which the game image 101 is displayed includes the frontal direction of the slot machine 1, other players who are not playing the game with the slot machine 1 can visually recognize the history image 102 while the player playing the game with the slot machine 1 can visually recognize the game image 101.

In addition, since the game history of the game displayed in the history image 102 is the game history of the game of the slot machine played on current day or during a plurality of days, other players who wish to play the game in the fixture can easily grasp the state of the slot machine 1 and thus the convenience is improved.

### SECOND EXAMPLE (EXAMPLE 2)

Next, the main control program executed in the slot machine according to a second example of the present embodiment will be described in detail with reference to drawings (especially, FIGS. 9 to 12). FIG. 9 is a diagram for describing explanatory notes which are displayed on the upper image display panel 7 with predetermined timing and can be recognized visually by the players situated in the second viewing angle direction 98 and the third viewing angle direction 99 (refer to FIG. 2). Specifically, FIG. 9 is a diagram for describing the explanatory notes to be displayed on the upper image display panel 7 in the slot machine 1 according to the present example.

As shown in FIG. 9, for example, while the slot machine 1 is executing the base game, an explanatory note “if three bonus game symbols are aligned, you can move to the bonus game” is displayed in order to explain the game contents of the base game to the players therearound. Due to this, it is made possible for the players therearound to grasp the condition to move to the bonus game with the slot machine 1.

In addition, while the slot machine 1 is executing the bonus game, an explanatory note “You can select any treasure chest to obtain payout to be displayed” is displayed in order to explain the game contents of the bonus game to the players therearound. This enables the players therearound to grasp the playing method of the bonus game with the slot machine 1.

In addition, when a base winning pattern is won as the result of the internal lottery in the base game in the slot machine 1, an explanatory note “The pattern of OO (for example, CHERRY etc.) will be aligned” is displayed in order to explain in advance to the players therearound that the base winning pattern is won before the symbols of the reels 5L, 5C, and 5R come to a stop to be displayed.

In addition, when the bonus game trigger is won as the result of the internal lottery in the base game in the slot machine 1, an explanatory note “Soon, you move to the bonus game” is displayed in order to explain in advance to the players therearound that the bonus game trigger is won before the symbols of the reels 5L, 5C, and 5R come to a stop to be displayed.

On the other hand, none of the winning patterns is won as the result of the internal lottery in the base game in the slot machine 1, no explanatory note will be displayed.

In addition, when any one of the treasure chests to be displayed is associated with a pattern of JP jackpot) as the result of the internal lottery in the bonus game in the slot machine 1, an explanatory note “There is the possibility of obtaining JP depending on the player's selection” is displayed in order to explain in advance to the players therearound that there is the possibility of obtaining JP by the player.

On the other hand, none of the treasure chests to be displayed is associated with a pattern of JP jackpot) as the result of the internal lottery in the bonus game by the slot machine 1, no explanatory note will be displayed.

From the above, the current state of the game in progress with the slot machine 1 can be explained to the players situated around the slot machine 1 based on various patterns based on the gaming mode and the internal lottery result. Consequently, the state of the game with the slot machine 1 can be grasped and the game can be watched without getting tired thereof.

Next, the main control program executed in the slot machine 1 according to the present second example will be described in detail with reference to drawings. FIG. 6 is a flow chart of the main control program.

It is assumed that the memory card 53 has already been inserted into the card slot 53S of the gaming board 50 and the GAL 54 is attached to the IC socket 54S in the slot machine 1.

First, when the power supply switch is turned on (the turning on of the power supply) in the power supply unit 45, the motherboard 40 and the gaming board 50 are activated, respectively, and an authentication read process in S1 is executed. In this authentication read process, the motherboard 40 and the gaming board 50 execute the individual processes in parallel, respectively.

In other words, on the gaming board 50, the CPU 51 reads the preliminary authentication program stored in the boot ROM 52 and executes a preliminary authentication in accordance with the read preliminary authentication program to check and prove in advance, before being taken into the motherboard 40, that the authentication program has not been altered.

On the other hand, on the motherboard 40, the main CPU 41 executes the BIOS stored in the ROM 42 and decompresses the compressed data embedded in the BIOS into the RAM 43 and executes the BIOS decompressed into the RAM 43 and diagnosis and initialization of various peripheral units.

Then, the main CPU 41 reads the authentication program stored in the ROM 55 and executes authentication to check and prove that the game programs etc. stored in the memory card 53 inserted into the card slot 53S have not been altered. When the authentication process is completed normally, the main CPU 41 writes the game programs etc. for which authentication has been executed (the authenticated game programs) into the RAM 43 and acquires the payout rate setting data and country identification information.

After executing the above-described processes, the main CPU 41 completes the authentication read process.

Then, in S2, the main CPU 41 reads the game programs etc. authenticated in the authentication read process in S1 mentioned above sequentially from the RAM 43 and executes them and executes a main game process. By the execution of the main game process, the game in the slot machine 1 according to the present example is played. Then, the main game process is executed repeatedly while the power is being supplied to the slot machine 1.

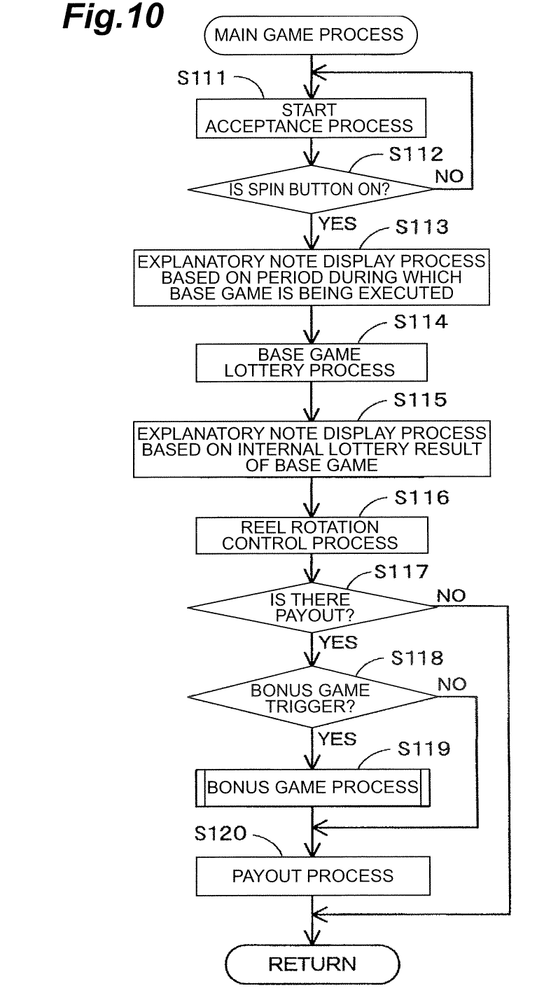

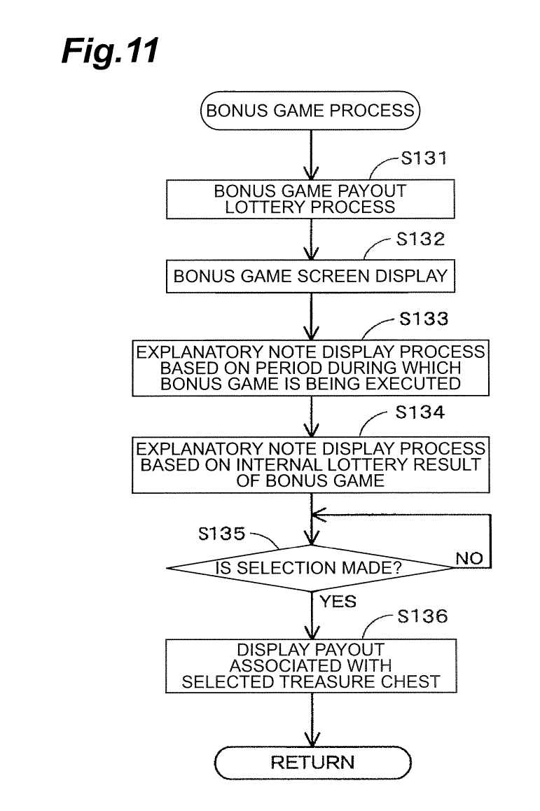

Next, the main game process in S2 mentioned above will be described. FIG. 10 is a flow chart of the main game process program in the slot machine according to the present second example. Each program indicated by the flow chart in FIG. 10 and FIG. 11 is stored in the ROM 42 and the RAM 43 included in the slot machine 1 and is executed by the main CPU 41.

First, as shown in FIG. 10, after executing the predetermined initial setting, the main CPU 41 executes the start acceptance process for setting the number of bets etc. for the insertion of coins and the winning line L in S111. At this time, in the start acceptance process, the player inserts coins and performs the bet operation using the 1-BET button 16 and the maximum BET button 17.

Next, in S112, the main CPU 41 determines whether or not there is an input from the spin button 13. Whether or not there is an input from the spin button 13 is determined based on whether or not the input signal from the spin switch 13S is received.

When there is no input from the spin button 13 (S112 NO), the process returns to the start acceptance process (S111) again. At this time, the operation, such as modification of the number of bets, is made possible. On the other hand, when there is an input from the spin button 13 (S112: YES), the main CPU 41 subtracts the number of bets set for the winning line L based on the operation of the 1-BET button 16 and the maximum BET button 17 from the number of possessed credits, and stores it in the RAM 43 as bet information.

Then, in S113 and after that step, the main CPU 41 executes the base game process using the reels 5L, 5C, and 5R. When the base game process is started, the upper image display panel 7 is first controlled so as to display the game image relating to the game of the slot machine 1 and the explanatory image relating to the description of the game (S113).

Specifically, the slot machine 1 according to the present example creates the game image 201 relating to the game of the slot machine 1, such as effects and advance notices using characters etc., by the VDP of the graphic board 68 and stores the image in the video RAM 69. On the other hand, by reading an explanatory note that describes the game contents of, particularly, the base game, among the explanatory notes (refer to FIG. 9) stored in the ROM 42, the slot machine 1 creates the explanatory image 202 relating to the description of the game by the VDP of the graphic board 68 and stores the image in the video RAM 69.

As mentioned above, the upper image display panel 7 is configured by the duel-view liquid crystal and displays the game image 201 read from the video RAM 69 using the pixel column 93 of the pixelated image display layer 91 for the player situated in the first viewing angle direction 97 (refer to FIG. 2) including the frontal direction of the slot machine 1. On the other hand, the upper image display panel 7 displays the explanatory image 202 read from the video RAM 69 using the pixel columns 94 and 95 of the pixelated image display layer 91 for other players situated in the second viewing angle direction 98 and the third viewing angle direction 99 (refer to FIG. 2) different from the first viewing angle direction 97. This allows the player who plays the game with the slot machine 1 to easily grasp the game contents of the base game being played with the slot machine 1 by referring to the upper image display panel 7, while enjoying the game by referring to the upper image display panel 7.

Next, in S114, the main CPU 41 executes the base game lottery process. Specifically, the main CPU 41 selects random number values corresponding to the three reels 5L, 5C, and 5R, respectively, within the numerical range of “0 to 255” by executing the random number generation program included in the lottery program stored in the RAM 43. Then, the main CPU 41 refers to the symbol weighting data in accordance with the payout rate setting data and determines the code No. of each of the reels 5L, 5C, and 5R (refer to FIG. 3) based on the three selected random number values. After storing the determined code No. of each of the reels 5L, 5C, and 5R in the RAM 43, the main CPU 41 proceeds to S115.

Here, since the code No. of each of the reels 5L, 5C, and 5R corresponds to the code No. of the symbol that comes to a stop to be displayed on the winning line L, the pattern of the game is determined by the main CPU 41 determining the code No. of each of the reels 5L, 5C, and 5R. For example, if the main CPU 41 determines the code No. of each of the reels 5L, 5C, and 5R as “00”, “00”, and “00”, it means that the main CPU 41 has determined the pattern as “RED7”. In this manner, by determining the code No. of each of the reels 5L, 5C, and 5R, the lottery relating to the base pattern (refer to FIG. 5) is executed.

Then, in S115, the upper image display panel 7 is controlled so as to display the explanatory image relating to the description of the game based on the internal lottery result of the slot machine 1.

Specifically, the slot machine 1 according to the present example reads an explanatory note that describes the internal lottery result of, particularly, the base game, among the explanatory notes (refer to FIG. 9) stored in the ROM 42 to create the explanatory image 202 relating to the description of the game by the VDP of the graphic board 68 and stores the image in the video RAM 69. Further, the explanatory image 202 read from the video RAM 69 is displayed using the pixel columns 94 and 95 of the pixelated image display layer 91 for other players situated in the second viewing angle direction 98 and the third viewing angle direction 99 (refer to FIG. 2). This enables the player who plays the game with the slot machine 1 to enjoy the game by referring to the upper image display panel 7, while other players to grasp in advance the lottery result of the base game by the slot machine 1 by referring to the upper image display panel 7 at the same time. The explanatory note displayed in S115 based on the internal lottery result of the base game is erased once when the reels 5L, 5C, and 5R come to a stop to be displayed in S116 to be described later, and an explanatory note based on the period during which the base game is being executed is displayed again.

Next, in S116, the main CPU 41 executes a reel rotation control process. The reel rotation control process is a process in which the rotation of each of the reels 5L, 5C, and 5R is stopped after the rotation of all of the reels 5L, 5C, and 5R is started so that a combination of the symbols determined in the base game lottery process (S114) comes to a stop to be displayed on the winning line L. This process is a process executed between the main CPU 41 and the sub CPU 61.

To describe specifically, in the reel rotation control process (S116), the main CPU 41 first transmits a start signal to start rotation of the reels to the sub CPU 61. The sub CPU 61, upon receipt of the start signal, executes the reel rotation process. In other words, the sub CPU 61 drives each of the stepping motors 70L, 70C, and 70R by the motor driving circuit 62 and the driver 64 to start the rotation of each of the reels 5L, 5C, and 5R.

Then, after transmitting the start signal, the main CPU 41 determines the effect pattern for one game (pattern such as display of an image on the lower image display panel 6, output of sound from the speaker 28, etc.) and starts the effect with the determined effect pattern.

After this, when predetermined stop timing of stopping the rotation of the reels 5L, 5C, and 5R is reached, the main CPU 41 transmits the code No. of the reel stored in the RAM 43 to the sub CPU 61. The sub CPU 61 executes the reel stop process based on the code No. of the reel. This causes the symbol corresponding to the lottery result to come to a stop to be displayed on the winning line L of each of the display windows 10L, 10C, and 10R.

Then, in S117, the main CPU 41 determines whether or not payout has been made in the slot machine 1. As a result, when any one of the patterns shown in FIG. 5 is achieved (S117: YES), the process proceeds to S118. On the other hand, when none of the patterns is achieved (S117: NO), the main game process is completed.

In S118, the main CPU 41 determines whether or not the bonus game trigger has been achieved in the base game. Specifically, it is determined that the bonus game trigger has been achieved when the combination of the “RED7” symbols comes to a stop to be displayed on the winning line L.

Then, when it is determined that the bonus game trigger has been achieved (S118: YES), the main CPU 41 executes the selection type bonus game process to be described later (refer to FIG. 11) in step S119 and then pays the payout obtained from the base game and the bonus game, respectively, to the player (S120). At this time, it is also possible to pay out as coins in accordance with the number of credits (one credit corresponds to one coin) by pressing down the CASHOUT button 15, or to pay out as the bar-coded ticket 25.

On the other hand, when it is determined that the bonus game trigger has not been achieved (S118: NO), the payout obtained from the base game is paid out to the player (S120).

Next, the bonus game process in S119 mentioned above executed in the slot machine 1 according to the present example will be described in detail with reference to FIG. 11. FIG. 11 is a flow chart of the bonus game process program in the slot machine 1 according to the present example.

As shown in FIG. 11, in S131, the main CPU 41 associates payout with the three treasure chests, which are the choices displayed on the lower image display panel 6, by lottery. Specifically, this is done by selecting payout (for example, “obtainment of JP”, “payout of 200 credits”, “payout of 100 credits”, “lost”, etc.) based on the sampled random number value and the bonus game lottery table (not shown) stored in the ROM 42.

Then, in S132, the main CPU 41 displays the bonus game screen on the lower image display panel 6. Further, in S133, the main CPU 41 controls the upper image display panel 7 so as to display the explanatory image that describes the bonus game of the slot machine 1. Here, FIG. 12 is a diagram showing an example of the game image 201 and the explanatory image 202 displayed on the upper image display panel 7 during the execution of the bonus game. The explanatory image 202 shown in FIG. 12 is one piece of the game information based on the game process relating to the game controlled by a processor, such as the main CPU 41, that is, a description of the game based on the result of the lottery executed by the processor.

Specifically, the slot machine 1 according to the present second example creates the game image 201 relating to game of the slot machine 1, such as effects and advance notices using characters etc., by the VDP of the graphic board 68 and stores the image in the video RAM 69. On the other hand, by reading an explanatory note that describes the game contents of, particularly, the bonus game, among the explanatory notes (refer to FIG. 9) stored in the ROM 42, the slot machine 1 creates the explanatory image 202 relating to the description of the game by the VDP of the graphic board 68 and stores the image in the video RAM 69.

As mentioned above, the upper image display panel 7 is configured by the duel-view liquid crystal and displays the game image 201 read from the video RAM 69 using the pixel column 93 of the pixelated image display layer 91 for the player situated in the first viewing angle direction 97 (refer to FIG. 2) including the frontal direction of the slot machine 1. FIG. 12 shows the game image 201 that displays in particular that the bonus game is won and the bonus game is being executed using the effect, and also displaying that the bonus game is won together with the amount of JP. It may also be possible to display the payout table and the bonus game screen in the game image 201.

On the other hand, the upper image display panel 7 displays the explanatory image 202 read from the video RAM 69 using the pixel columns 94 and 95 of the pixelated image display layer 91 for other players situated in the second viewing angle direction 98 and the third viewing angle direction 99 (refer to FIG. 2) different from the first viewing angle direction 97. In FIG. 12, the explanatory image 202 is displayed, which includes an explanatory note “You can select any treasure chest to obtain payout to be displayed” in order to describe the game contents of the bonus game for, in particular, the players therearound. This enables the players therearound to easily grasp the playing method of the bonus game with the slot machine 1.

Next, in S134, the upper image display panel 7 is controlled so as to display the explanatory image relating to the description of the game based on the result of the internal lottery of the slot machine 1.

Specifically, the slot machine 1 according to the present example reads an explanatory note that describes the internal lottery result of, particularly, the bonus game, among the explanatory notes (refer to FIG. 9) stored in the ROM 42 to create the explanatory image 202 relating to the description of the game by the VDP of the graphic board 68 and stores the image in the video RAM 69. Further, the explanatory image 202 read from the video RAM 69 is displayed using the pixel columns 94 and 95 of the pixelated image display layer 91 for other players situated in the second viewing angle direction 98 and the third viewing angle direction 99 (refer to FIG. 2). This enables the player who plays the game with the slot machine 1 to enjoy the game by referring to the upper image display panel 7, while other players to grasp in advance the lottery result of the bonus game by the slot machine 1 by referring to the upper image display panel 7 at the same time. The explanatory note displayed in S134 based on the internal lottery result of the bonus game is erased once when a predetermined period of time elapses after it is displayed (for example, after a lapse of three seconds), and an explanatory note based on the period while the bonus game is being executed is displayed again.

After this, in S135, whether or not each treasure chest displayed on the bonus game screen has been selected by the player is determined based on the operation information from the touch panel 11. Then, when it is determined that selection has not been made (S135: NO), the standby state is kept until contacted. On the other hand, when it is determined that selection has been made (S135: YES), the process shifts to S136.

In S136, the main CPU 41 displays the payout associated with the selected treasure chest on the lower image display panel 6. Then, the process shifts to the payout process in S120, in which the payout obtained from the bonus game is made.

As described above, in the slot machine according to the present second example, the upper image display panel 7 is configured by the duel-view liquid crystal and for the player situated in the first viewing angle direction 97 (refer to FIG. 2) including the frontal direction of the slot machine 1, the game image 201 relating to the game of the slot machine 1 is displayed, and for other players situated in the second viewing angle direction 98 and the third viewing angle direction 99 (refer to FIG. 2) different from the first viewing angle direction 97, the explanatory image 202 relating to the description of the game based on the current gaming mode of the slot machine 1 and the internal lottery result is displayed, and therefore, the proper images can simultaneously be displayed to the player playing the game and other players respectively by only one display means without the need to operate a switching switch etc. Consequently, the understanding of the game by other players watching the game can be promoted without interfering with the player's game and thus the convenience of the player is improved

In addition, since other players therearound can grasp in advance the internal lottery result of the base game and the bonus game of the slot machine 1, they can watch the game without getting tired thereof.

In addition, since the first viewing angle direction 97 in which the game image 201 is displayed includes the frontal direction of the slot machine 1, the player playing the game with the slot machine 1 can visually recognize the game image 201, while other players who are not playing the game with the slot machine 1 can visually recognize the explanatory image 202 at the same time.

### THIRD EXAMPLE (EXAMPLE 3)

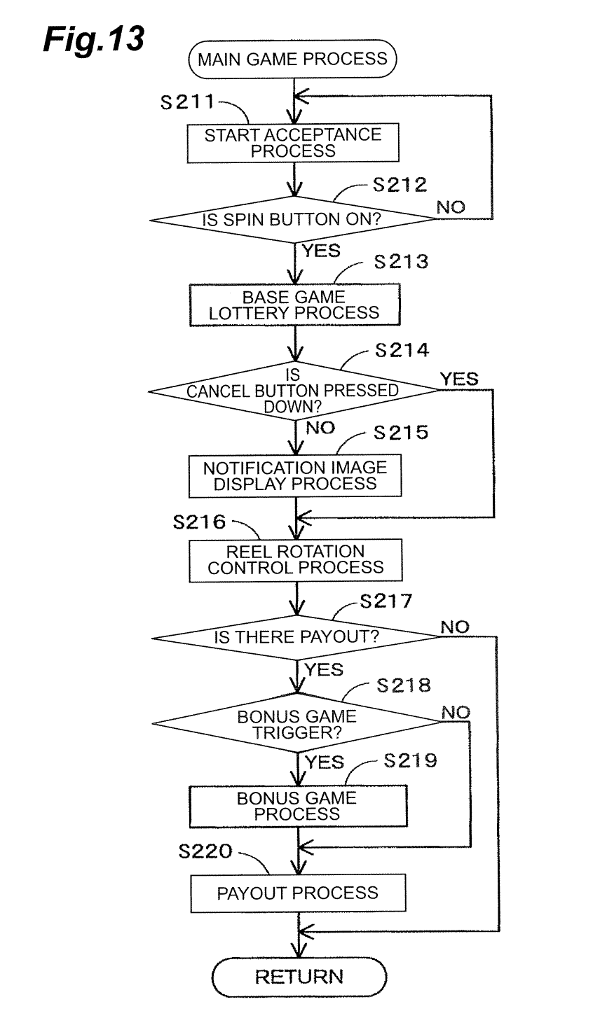

Next, the main control program executed in the slot machine according to a third example of the present embodiment will be described in detail with reference to drawings (especially, FIGS. 13 to 15). FIG. 6 is a flow chart of the main control program.

It is assumed that the memory card 53 has already been inserted into the card slot 53S of the gaming board 50 and the GAL 54 is attached to the IC socket 54S in the slot machine 1.

First, when the power supply switch is turned on (the turning on of the power supply) in the power supply unit 45, the motherboard 40 and the gaming board 50 are activated, respectively, and an authentication read process in S1 is executed. In this authentication read process, the motherboard 40 and the gaming board 50 execute the individual processes in parallel, respectively.

In other words, on the gaming board 50, the CPU 51 reads the preliminary authentication program stored in the boot ROM 52 and executes a preliminary authentication in accordance with the read preliminary authentication program to check and prove in advance, before being taken into the motherboard 40, that the authentication program has not been altered.

On the other hand, on the motherboard 40, the main CPU 41 executes the BIOS stored in the ROM 42 and decompresses the compressed data embedded in the BIOS into the RAM 43 and executes the BIOS that has been decompressed into the RAM 43 and diagnosis and initialization of various peripheral units.

After this, the main CPU 41 reads the authentication program stored in the ROM 55 and executes authentication to check and prove that the game programs etc. stored in the memory card 53 inserted into the card slot 53S have not been altered. When the authentication process is completed normally, the main CPU 41 writes the game programs etc. for which authentication has been executed (the authenticated game programs) into the RAM 43 and acquires the payout rate setting data and country identification information.

After executing the above-described processes, the main CPU 41 completes the authentication read process.

Then, in S2, the main CPU 41 reads the game programs etc. authenticated in the authentication read process in S1 mentioned above, sequentially from the RAM 43 and executes them and executes a main game process. By the execution of the main game process, the game in the slot machine 1 according to the present example is played. Then, the main game process is executed repeatedly while the power is being supplied to the slot machine 1.

Here, when the main game process is executed in S2 mentioned above, the upper image display panel 7 is controlled so as to display the game image 301 relating to the game contents of the slot machine 1 and the during-game image 303 that notifies that the player is playing with the slot machine 1. Here, FIG. 14 shows an example of the game image 301 and the during-game image 303 (notification information) displayed on the upper image display panel 7 in the main game process. The during-game image 303 shown in FIG. 14 is one piece of the game information based on the game process relating to the game controlled by a processor, such as the main CPU 41, that is, the notification information that notifies the state of the game process being executed by the processor.

Specifically, the slot machine 1 according to the present example creates the game image 301 relating to the game contents, such as the payout table and the accumulated amount of JP jackpot), by the VDP of the graphic board 68 and stores the image in the video RAM 69. On the other hand, the slot machine 1 creates the during-game image 103 composed of letters “Now Playing” and a character notifying that the player is playing with the slot machine 1 by the VDP of the graphic board 68 and stores the image in the video RAM 69.

As mentioned above, the upper image display panel 7 is configured by a duel-view liquid crystal and displays the game image 301 read from the video RAM 69 using the pixel column 93 of the pixelated image display layer 91 for the player situated in the first viewing angle direction 97 (refer to FIG. 2) including the frontal direction of the slot machine 1. FIG. 14 shows the game image 301 notifying the player of the payout table and the accumulated amount of JP in particular and in the game image 301, the combinations of winning pattern and the corresponding payout and amount of JP are displayed, respectively. It may also be possible to display the effect screen using characters in the game image 301.

On the other hand, the upper image display panel 7 displays the during-game image 303 read from the video RAM 69 using the pixel columns 94 and 95 of the pixelated image display layer 91 for other players situated in the second viewing angle direction 98 and the third viewing angle direction 99 (refer to FIG. 2) different from the first viewing angle direction 97. FIG. 14 shows the during-game image 303 displaying the letters “Now Playing” in particular and other players can grasp that the player is playing with the slot machine 1 by referring to the during-game image 303.

Next, the main game process in S2 mentioned above will be described based on FIG. 13. FIG. 13 is a flow chart of the main game process program in the slot machine according to the present example. Each program shown below by the flow chart of FIG. 13 is stored in the ROM 42 and the RAM 43 included in the slot machine 1 and is executed by the main CPU 41.

First, as shown in FIG. 13, after executing the predetermined initial setting, the main CPU 41 executes the start acceptance process for setting the number of bets etc. for the insertion of coins and the winning line L in S211. At this time, in the start acceptance process, the player inserts coins and performs the bet operation using the 1-BET button 16 and the maximum BET button 17.

Next, in S212, the main CPU 41 determines whether or not there is an input from the spin button 13. Whether or not there is an input from the spin button 13 is determined based on whether or not the input signal from the spin switch 13S is received.

When there is no input from the spin button 13 (S212: NO), the process returns to the start acceptance process (S211) again. At this time, the operation, such as modification of the number of bets, is made possible. On the other hand, when there is an input from the spin button 13 (S212: YES), the main CPU 41 subtracts the number of bets set for the winning line L based on the operation of the 1-BET button 16 and the maximum BET button 17 from the number of possessed credits and stores it in the RAM 43 as bet information.

Next, in S213, the main CPU 41 executes the base game lottery process. Specifically, the main CPU 41 selects random number values corresponding to the three reels 5L, 5C, and 5R, respectively, within the numerical range of “0 to 255” by executing the random number generation program included in the lottery program stored in the RAM 43. Then, the main CPU 41 refers to the symbol weighting data in accordance with the payout rate setting data and determines the code No. of each of the reels 5L, 5C, and 5R (refer to FIG. 3) based on the three selected random number values. After storing the determined code No. of each of the reels 5L, 5C, and 5R in the RAM 43, the main CPU 41 shifts to S214.

Here, since the code No. of each of the reels 5L, 5C, and 5R corresponds to the code No. of the symbol that comes to a stop to be displayed on the winning line L, the pattern of the game is determined by the main CPU 41 determining the code No. of each of the reels 5L, 5C, and 5R. For example, if the main CPU 41 determines the code No. of each of the reels 5L, 5C, and 5R as “00”, “00”, and “00”, it means that the main CPU 41 has determined the pattern as “RED7”. In this manner, by determining the code No. of each of the reels 5L, 5C, and 5R, the lottery relating to the base pattern (refer to FIG. 5) is executed.

After this, in S214, the CPU 41 determines whether or not the cancel button 18 has been pressed down by the player. Then, when it is determined that the cancel button 18 has not been pressed down (S214: NO), instead of the during-game image 103 to be displayed on the upper image display panel 7, the notification image 302 notifying the internal lottery result of the base game in S213 mentioned above is displayed (S215).

Specifically, the slot machine 1 according to the present example creates the notification image 302 showing the internal lottery result by the VDP of the graphic board 68 and stores the image in the video RAM 69. Then, the notification image 302 read from the video RAM 69 is displayed using the pixel columns 94 and 95 of the pixelated image display layer 91 for other players situated in the second viewing angle direction 98 and the third viewing angle direction 99 (refer to FIG. 2) different from the first viewing angle direction 97. This allows highlighting the game result of the game being played with the slot machine 1 both sufficiently and effectively to other players who are not playing with the slot machine 1. The notification image 302 displayed in S215 is erased once when a predetermined period of time elapses (for example, after the reels 5L, 5C, and 5R come to a stop to be displayed), and the during-game image 303 is displayed again.

Here, FIG. 15 is a diagram showing the notification image 302 displayed on the upper image display panel 7 with the timing that the pattern of “RED 7” is won, which is the bonus game trigger, by the internal lottery result in S215 mentioned above in particular and before the combination of symbols, which is the winning pattern of “RED7”, comes to a stop to be displayed on the winning line L. The notification image 302 shown in FIG. 15 is one piece of the game information based on the game process relating to the game controlled by a processor, such as the main CPU 14, that is, the notification information notifying the result of the lottery executed by the processor.

As shown in FIG. 15, before the reels 5L, 5C, and 5R come to a stop to be displayed, only the other players situated in the second viewing angle direction 98 and the third viewing angle direction 99 (refer to FIG. 2) are notified that the probability of winning the bonus game is high using the notification image 302 composed of the letters “Bonus Chance!” This allows notifying in advance only the player now playing the game of the lottery result (possibility of winning pattern) without using a plurality of displays.

On the other hand, when it is determined that the cancel button 18 has been pressed down (S214: YES), the during-game image 303 is being displayed continuously on the upper image display panel 7 without displaying the notification image 302.

Next, in S216, the main CPU 41 executes a reel rotation control process. The reel rotation control process is a process in which the rotation of each of the reels 5L, 5C, and 5R is stopped after the rotation of all of the reels 5L, 5C, and 5R is started so that a combination of the symbols determined by the base game lottery process (S213) comes to a stop to be displayed on the winning line L. This process is a process executed between the main CPU 41 and the sub CPU 61.

To describe specifically, in the reel rotation control process (S216), the main CPU 41 first transmits a start signal to start rotation of the reels to the sub CPU 61. The sub CPU 61, upon receipt of the start signal, executes the reel rotation process. In other words, the sub CPU 61 drives each of the stepping motors 70L, 70C, and 70R by the motor driving circuit 62 and the driver 64 to start the rotation of each of the reels 5L, 5C, and 5R.

Then, after transmitting the start signal, the main CPU 41 determines the effect pattern for one game (pattern such as display of an image on the lower image display panel 6 and output of sound from the speaker 28) and starts the effect with the determined effect pattern.

After this, when predetermined stop timing of stopping the rotation of the reels 5L, 5C, and 5R is reached, the main CPU 41 transmits the code No. of the reel stored in the RAM 43 to the sub CPU 61. The sub CPU 61 executes the reel stop process based on the code No. of the reel. Thereby, the symbol corresponding to the lottery result comes to a stop to be displayed on the winning line L of each of the display windows 10L, 10C, and 10R.

Further, in S217, the main CPU 41 determines whether or not payout has been made in the slot machine 1. As a result, when any one of the patterns shown in FIG. 5 is achieved (S217: YES), the process shifts to S218. On the other hand, when none of the patterns is achieved (S217: NO), the main game process is completed.

In S218, the main CPU 41 determines whether or not the bonus game trigger has been achieved in the base game. Specifically, it is determined that the bonus game trigger has been achieved when the combination of the “RED7” symbols comes to a stop to be displayed on the winning line L.

Then, when it is determined that the bonus game trigger has been achieved (S218: YES), the main CPU 41 executes the selection type bonus game process in step S219. The details of the bonus game process are omitted, however, it can be the same as the bonus game process in the above-mentioned second example. Then, the CPU 41 pays the payout obtained from the base game and the bonus game, respectively, to the player (S220). At this time, it is also possible to pay out as coins in accordance with the number of credits (one credit corresponds to one coin) by pressing down the CASHOUT button 15, or to pay out as the bar-coded ticket 25.

On the other hand, when it is determined that the bonus game trigger has not been achieved (S218: NO), the payout (refer to FIG. 5) obtained from the base game is paid out to the player (S220).

As described above, in the slot machine according to the present third example, the upper image display panel 7 is configured by the duel-view liquid crystal and before the reels 5L, 5C, and 5R come to a stop to be displayed, for the player situated in the second viewing angle direction 98 and the third viewing angle direction 99 (refer to FIG. 2) corresponding to the rightward and leftward directions of the slot machine 1, the notification image 302 notifying the lottery result of the internal lottery of the slot machine 1 is displayed, and therefore, the lottery result for a long time can be displayed using the wide area of the upper image display panel 7 for persons around the slot machine 1, while displaying the game image relating to the game for the player who is playing, without the need to use a plurality of displays.

In addition, since the notification image 302 is controlled so as not to be displayed when the cancel button is pressed down (S214: YES), the game result can be notified only to a player based on the will of the player. Consequently, the lottery result can be hided when the player does not wish other persons therearound to know the lottery result and the convenience of the player is improved.

In addition, since the first viewing angle direction 97 in which the game image 301 is displayed includes the frontal direction of the slot machine 1, the lottery result for a long time can be displayed using the wide area of the upper image display panel 7 for persons therearound, who are not playing the game with the slot machine 1, while displaying the game image relating to the game for the player who plays the game with the slot machine 1.

As described above, in the gaming machine according to the present invention, the display means, such as a display, is controlled so as to display the game image relating to the game as the first image that can be recognized visually from the first viewing angle direction and is also controlled so as to display game information based on the control process relating to the game controlled by each control means and/or lottery means, such as a processor, in the second image that can be recognized visually from the second viewing angle direction. In more detail, it is possible to configure the gaming machine according to the present invention as follows.

First, the gaming machine according to the present invention is one (for example, the slot machine 1) having an operation acceptance means (for example, the spin button 13, the 1-BET button 16, the maximum BET button 17) for accepting the operation of a player and a game control means (for example, the main CPU 41) for controlling the game based on the operation of the player accepted by the operation acceptance means, being characterized by having a display means (for example, the upper image display panel 7) for simultaneously displaying the first image (for example, the game image 101) that can be recognized visually from the first viewing angle direction (for example, the first viewing angle direction 97) and the second image (for example, the history image 102) that can be recognized visually from the second viewing angle direction (for example, the second viewing angle direction 98, the third viewing angle direction 99) different from the first viewing angle direction and a display control means (for example, the main CPU 41, the graphic board 68) for controlling the display means so as to display the game image relating to the game controlled by the game control means in the first image and to display the history image relating to the game history of the game controlled by the game control means in the second image.

With such a configuration, the display means displays the game image relating to the game as the first image that can be recognized visually from the first viewing angle direction and the history image relating to the game history of the game in the second image that can be recognized visually from the second viewing angle direction, and therefore the proper images can be displayed simultaneously to the player who plays the game and other players, respectively, by the single display means without the need to operate a switching switch etc. Consequently, useful information can be provided easily to other players who wish to play the game in the future without interfering with the player's game and thus the convenience of the player is improved.

In addition, the gaming machine according to the present invention can be characterized in that the first viewing angle direction (for example, the first viewing angle direction 97) includes, in the above-mentioned gaming machine (for example, the slot machine 1), the frontal direction of the gaming machine.

In addition, with such a configuration, the first viewing angle direction in which the game image is displayed includes the frontal direction of the gaming machine, and therefore, other players not playing the game with the gaming machine can visually recognize the history image while the player playing the game with the gaming machine visually recognizes the game image simultaneously.

Further, the gaming machine according to the present invention can be characterized in that the game history of the game displayed in the second image (for example, the history image 102) is, in the above-mentioned gaming machine (for example, the slot machine 1), the game history of the game played on current day or during a plurality of days with the gaming machine.

With such a configuration, the game history of the game displayed in the second image is the game history of the game played on current day or during the plurality of days with the gaming machine, and therefore other players wishing to play the game in the future can easily grasp the state of the gaming machine and the convenience is improved.

In addition, the gaming machine according to the present invention can be configured as follows.

Specifically, the gaming machine according to the present invention is one (for example, the slot machine 1) having an operation acceptance means (for example, the spin button 13, the 1-BET button 16, the maximum BET button 17) for accepting the operation of a player, a lottery means (for example, the main CPU 41, S14, S31) for executing the lottery relating to the game, and a game control means (for example, the main CPU 41) for controlling the game based on the operation of the player accepted by the operation acceptance means and the result of the lottery by the lottery means, being characterized by having a display means (for example, the upper image display panel 7) for simultaneously displaying the first image (for example, the game image 201) that can be recognized visually from the first viewing angle direction (for example, the first viewing angle direction 97) and the second image (for example, the explanatory image 202) that can be recognized visually from the second viewing angle direction (for example, the second viewing angle direction 98, the third viewing angle direction 99) different from the first viewing angle direction and a display control means (for example, the main CPU 41, the graphic board 68) for controlling the display means so as to display the game image relating to the game controlled by the game control means in the first image and to display the description of the game based on the result of the lottery by the lottery means in the second image.

With such a configuration, the display means displays the game image relating to the game as the first image that can be recognized visually from the first viewing angle direction and displays the description of the game based on the lottery result of the gaming machine in the second image that can be recognized visually from the second viewing angle direction, and therefore the proper images can be displayed simultaneously to the player who plays the game and other players, respectively, by the single display means without the need to operate a switching switch etc. Consequently, the understanding of the game by other players watching the game can be promoted without interfering with the player's game and thus the convenience of the player is improved.

In addition, the gaming machine according to the present invention is one (for example, the slot machine 1) having an operation acceptance means (for example, the spin button 13, the 1-BET button 16, the maximum BET button 17) for accepting the operation of a player and a game control means (for example, the main CPU 41) for controlling the game by a plurality of gaming modes based on the operation of the player accepted by the operation acceptance means, being characterized by having a display means (for example, the upper image display panel 7) for simultaneously displaying the first image (for example, the game image 201) that can be recognized visually from the first viewing angle direction (for example, the first viewing angle direction 97) and the second image (for example, the explanatory image 202) that can be recognized visually from the second viewing angle direction (for example, the second viewing angle direction 98, the third viewing angle direction 99) different from the first viewing angle direction and a display control means (for example, the main CPU 41, the graphic board 68) for controlling the display means so as to display the game image relating to the game controlled by the game control means in the first image and to display the description of the game based on the current gaming mode in the second image.

With such a configuration, the display means displays the game image relating to the game as the first image that can be recognized visually from the first viewing angle direction and displays the description of the game based on the current gaming mode in the second image that can be recognized visually from the second viewing angle direction, and therefore, the proper images can be displayed simultaneously to the player who plays the game and other players, respectively, by the single display means without the need to operate a switching switch etc. Consequently, the understanding of the game by other players watching the game can be promoted without interfering with the player's game and thus the convenience of the player is improved.

Further, the gaming machine according to the present invention can be characterized in that the first viewing angle direction (for example, the first viewing angle direction 97) includes, in the above-mentioned gaming machine (for example, the slot machine 1), the frontal direction of the gaming machine.

With such a configuration, the first viewing angle direction in which the game image is displayed includes the frontal direction of the gaming machine, and therefore, other players not playing the game with the gaming machine can visually recognize the description while the player who plays the game with the gaming machine visually recognizes the game image at the same time.

In addition, the gaming machine according to the present invention can be configured as follows.

Specifically, the gaming machine according to the present invention is one (for example, the slot machine 1) having an operation acceptance means (for example, the spin button 13, the 1-BET button 16, the maximum BET button 17, the cancel button 18) for accepting the operation of a player, a lottery means (for example, the main CPU 41, S15) for executing the lottery relating to the game, and a game control means (for example, the main CPU 41) for controlling the game based on the operation of the player accepted by the operation acceptance means and the result of the lottery by the lottery means, being characterized by having a display means (for example, the upper image display panel 7) for simultaneously displaying the first image (for example, the game image 301) that can be recognized visually from the first viewing angle direction (for example, the first viewing angle direction 97) and the second image (for example, the notification image 302) that can be recognized visually from the second viewing angle direction (for example, the second viewing angle direction 98, the third viewing angle direction 99) different from the first viewing angle direction and a display control means (for example, the main CPU 41, the graphic board 68) for controlling the display means so as to display the game image relating to the game controlled by the game control means in the first image and to display the notification image notifying the result of the lottery by the lottery means in the second image.

With such a configuration, the game image relating to the game is displayed in the first image that can be recognized visually from the first viewing angle direction and the notification image notifying the result of the lottery by the lottery means is displayed in the second image that can be recognized visually from the second viewing angle direction different from the first viewing angle direction, and therefore, the game image relating to the game can be displayed on one hand, and on the other hand, the lottery result for a long time can be displayed using the wide area of the display means without using a plurality of display means. Consequently, it is made possible to highlight the game result both sufficiently and effectively when the game result advantageous to the player, such as the winning of the bonus game and the obtainment of JP, is obtained.

In addition, the gaming machine according to the present invention is characterized in that the first viewing angle direction (for example, the first viewing angle direction 97) includes, in the above-mentioned gaming machine (for example, the slot machine 1), the frontal direction of the gaming machine.

In addition, with such a configuration, the first viewing angle direction in which the game image is displayed includes the frontal direction of the gaming machine, and therefore, the game image can be displayed for the player playing the game while displaying the lottery result for those around the gaming machine for a long time using the wide area of the display means without using a plurality of display means.

In the above, the “game image” includes images relating to an effect and advance notice displayed during the game, in addition to the images relating to the state of the game in progress and the result of the game played with the gaming machine.

In addition, the “game history” includes information about the lottery result of the game played with the gaming machine, the game media consumed or obtained by the player.

In addition, “to notify the lottery result” includes that the lottery result is implied using the effect by a character etc. in addition to the direct notification of the lottery result.

It is needless to say that the present invention is not limited to the above-mentioned examples and there can be various improvements and modifications in the scope not deviating from the gist of the present invention.

For example, in the present first example, the same history image 102 is displayed in the second viewing angle direction 98 and the third viewing angle direction 99. However, it may also be possible to display different history images in the second viewing angle direction 98 and the third viewing angle direction 99, respectively. For example, the number of times of winning of the bonus game on the current day may be displayed in the second viewing angle direction 98 and the number of times of winning of the bonus game during a plurality of days including the current day may be displayed in the third viewing angle direction 99.

In addition, in the present first example, the duel-view liquid crystal is used for the upper image display panel 7, however, the duel-view liquid crystal may be used for the lower image display panel 6. In this case, it is desirable to control so that the image of the reel is displayed in the first viewing angle direction 97 including the frontal direction of the slot machine 1 and the game history is displayed in the second viewing angle direction 98 and the third viewing angle direction 99.

In addition, in the present first example, an example of the application made to the liquid crystal panel included in the slot machine is described, however, the application can also be made to the liquid crystal panel included in a pachinko machine, a poker game machine, or the like.

Further, in the present second example, the same explanatory image 202 is displayed in the second viewing angle direction 98 and the third viewing angle direction 99, however, it may also be possible to display different explanatory images in the second viewing angle direction 98 and the third viewing angle direction 99, respectively. For example, the payout table may be displayed in the second viewing angle direction 98 and the condition of shift to the bonus game may be displayed in the third viewing angle direction 99 during the period of execution of the base game.

In addition, in the present second example, the duel-view liquid crystal is used for the upper image display panel 7, however, the duel-view liquid crystal may be used for the lower image display panel 6. In this case, it is desirable to control so that the image of the reel is displayed in the first viewing angle direction 97 including the frontal direction of the slot machine 1 and the description of the game is displayed in the second viewing angle direction 98 and the third viewing angle direction 99.

In addition, in the present second example, an example of the application made to the liquid crystal panel included in the slot machine is described, however, the application can also be made to the liquid crystal panel included in a pachinko-slot machine, a pachinko machine, a poker game machine, or the like.

In particular, in a competition game using a poker game or mahjongg, by displaying the cards or mahjongg tiles as the description of the game that can be recognized visually from the second viewing angle direction 98 or the third viewing angle direction 99, it is possible to make the players watching the game easily grasp the game.

Further, in the present third example, the same notification image 302 or the during-game image 303 (that is, notification information notifying the state of the game process) is displayed in the second viewing angle direction 98 and the third viewing angle direction 99, however, it may also be possible to display different images in the second viewing angle direction 98 and the third viewing angle direction 99, respectively. For example, the during-game image 303 may be displayed in the second viewing angle direction 98 and the help screen guiding the operation method, instead of the during-game image 303, may be displayed in the third viewing angle direction 99.

In addition, in the present third example, the duel-view liquid crystal is used for the upper image display panel 7, however, the duel-view liquid crystal may be used for the lower image display panel 6. In this case, it is desirable to control so that the image of the reel is displayed in the first viewing angle direction 97 including the frontal direction of the slot machine 1 and the result of the lottery of the internal lottery is displayed in the second viewing angle direction 98 and the third viewing angle direction 99.

In addition, in the present third example, an example of the application made to the liquid crystal panel included in the slot machine is described, however, for example, the application can also be made to the liquid crystal panel included in a pachinko-slot machine, a pachinko machine, a poker game machine, or the like. In particular, in a pachinko-slot machine, by displaying the non-dealers or the achievement of the winning flag, such as the bonus game, in the second viewing angle direction 98 and the third viewing angle direction 99 using the notification image, it is made possible to highlight the fact that the player is winning patterns without losing.

In addition, in the above, the slot machines according to the first to third examples are described individually, however, it is needless to say that the configuration in each example can be combined adequately.

What is claimed is:

1. A gaming machine comprising:
an operation controller accepting an operation of a player;
a processor controlling a game based on the operation of the player which is accepted by the operation controller; and
a display simultaneously displaying a first image that can be recognized visually from a first viewing angle direction and a second image that can be recognized visually from a second viewing angle direction different from the first viewing angle direction on a single image display panel,
wherein the processor controls the display so as to display a game image relating to the game as the first image and to display game information based on a game process relating to the game controlled by the processor as the second image.

2. The gaming machine according to claim 1,
wherein the game information displayed as the second image is history information relating to a history of the game process controlled by the processor.

3. The gaming machine according to claim 2,
wherein the first viewing angle direction includes a frontal direction of the gaming machine.

4. The gaming machine according to claim 2,
wherein the history information displayed as the second image is a game history of the game played one of on a current day and during a plurality of days.

5. The gaming machine according to claim 3,
wherein the history information displayed as the second image is a game history of the game played one of on a current day and during a plurality of days.

6. The gaming machine according to claim 1,
wherein the processor executes a lottery as the game process, and the game information displayed as the second image is a description of the game based on a result of a lottery executed by the processor.

7. The gaming machine according to claim 6,
wherein the first viewing angle direction includes a frontal direction of the gaming machine.

8. The gaming machine according to claim 1,
wherein the processor controls the game by a plurality of gaming modes, and the game information displayed as the second image is a description of the game based on a current gaming mode.

9. The gaming machine according to claim 8,
wherein the first viewing angle direction includes a frontal direction of the gaming machine.

10. The gaming machine according to claim 1,
wherein the processor executes a lottery as the game process, and the game information displayed as the second image is notification information notifying a result of the lottery executed by the processor.

11. The gaming machine according to claim 10,
wherein the first viewing angle direction includes a frontal direction of the gaming machine.

12. The gaming machine according to claim 1,
wherein the game information displayed as the second image is notification information notifying a state of the game process being executed by the processor.

13. The gaming machine according to claim 12,
wherein the first viewing angle direction includes a frontal direction of the gaming machine.
